(19) United States
(12) Patent Application Publication
(10) Pub. No.: US 2015/0178646 A1
(43) Pub. Date: Jun. 25, 2015

(54) INTEGRATED STRESS TESTING FRAMEWORK SYSTEM AND METHOD

(71) Applicant: SAS Institute Inc., Cary, NC (US)

(72) Inventors: Wei Chen, Apex, NC (US); Klas Jimmy Skoglund, Motala (SE)

(21) Appl. No.: 14/579,384

(22) Filed: Dec. 22, 2014

Related U.S. Application Data
(60) Provisional application No. 61/919,276, filed on Dec. 20, 2013.

(51) Int. Cl. G06Q 10/06

(52) U.S. Cl. CPC G06Q 10/0635

(57) ABSTRACT

Embodiments of the present invention may include an input interface, configured to receive a representation of a series of time horizons, the series of time horizons having at least two consecutive future time periods; a stress test scenario store, configured to receive an input representing stress test scenarios that have a stress test scenario frequency; a simulation scenarios generator, configured to generate a set of representations of random simulation scenarios, the random simulation scenarios having a simulation scenario frequency; a frequency adjuster engine, configured to synchronize the stress test scenario frequency and the simulation scenario frequency; a decision structure generator, configured to generate a decision data structure for the at least two consecutive future time periods, among other features.

### CROSS-REFERENCE TO RELATED APPLICATIONS

This is a non-provisional of and claims the benefit and priority under 35 U.S.C. §119(e) of U.S. Provisional App. No. 61/919,276, titled “Integrated Stress Testing Framework via Markov Switching Simulation.” That U.S. Provisional Application was filed on Dec. 20, 2013, and is incorporated by reference herein for all purposes.

### TECHNICAL FIELD

Certain aspects of this disclosure generally relate to evaluating risk for an entity. Specifically, various techniques and systems are provided for a multi-period integrated switching simulation that combines historical risk simulation with integrated risk stress testing.

### BACKGROUND

Capturing tail events, especially those that include the rare possibility of severe loss, is an important objective of modern risk analysis. There are two focuses of modern risk analysis: (1) past behavior of data; and (2) stress testing. However, viewing them as separate entities can prevent the risk analysis from getting a comprehensive view of the risk profile of an entity.

### SUMMARY

Embodiments of the present invention may include, for example, a computer-program product tangibly embodied in a non-transitory machine-readable storage medium, including instructions configured to cause a data processing apparatus to: receive a representation of a series of time horizons, the series of time horizons having at least two consecutive future time periods; receive an input representing stress test scenarios that have a stress test scenario frequency; generate a set of representations of random simulation scenarios, the random simulation scenarios having a simulation scenario frequency; synchronize the stress test scenario frequency and the simulation scenario frequency; generate a decision data structure for the at least two consecutive future time periods, wherein for a future time period of the at least two consecutive future time periods the decision data structure includes a stress test scenario from the stress test scenarios and a probability of the stress test scenario occurring, and wherein the stress test scenario and the probability of the stress test scenario occurring are based at least in part on the decision data structure for a time period previous to the future time period and the random simulation scenarios; and analyze entity data of an entity based on the decision data structure.

Further embodiments of the present invention may include, for example, an input interface, configured to receive a representation of a series of time horizons, the series of time horizons having at least two consecutive future time periods; a stress test scenario store, configured to receive an input representing stress test scenarios that have a stress test scenario frequency; a simulation scenarios generator, configured to generate a set of representations of random simulation scenarios, the random simulation scenarios having a simulation scenario frequency; a frequency adjuster engine, configured to synchronize the stress test scenario frequency and the simulation scenario frequency; a decision structure generator, configured to generate a decision data structure for the at least two consecutive future time periods, wherein for a future time period of the at least two consecutive future time periods the decision data structure includes a stress test scenario from the stress test scenarios and a probability of the stress test scenario occurring, and wherein the stress test scenario and the probability of the stress test scenario occurring are based at least in part on the decision data structure for a time period previous to the future time period and the random simulation scenarios; and an application and evaluation engine, configured to analyze entity data of an entity based on the decision data structure.

Further embodiments of the present invention may include, for example, a computer-implemented method comprising: receiving a representation of a series of time horizons, the series of time horizons having at least two consecutive future time periods; receiving an input representing stress test scenarios that have a stress test scenario frequency generating a set of representations of random simulation scenarios, the random simulation scenarios having a simulation scenario frequency; synchronizing the stress test scenario frequency and the simulation scenario frequency; generating a decision data structure for the at least two consecutive future time periods, wherein for a future time period of the at least two consecutive future time periods the decision data structure includes a stress test scenario from the stress test scenarios and a probability of the stress test scenario occurring, and wherein the stress test scenario and the probability of the stress test scenario occurring are based at least in part on the decision data structure for a time period previous to the future time period and the random simulation scenarios; and analyzing entity data of an entity based on the decision data structure.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present technology are described in detail below with reference to the following drawing figures.

FIG. 1 illustrates an example of a block diagram that provides a generalized illustration of hardware and software components of a risk management system, according to embodiments of the present technology.

FIG. 2 illustrates an example of a block diagram bus that provides a generalized illustration of hardware and software components of a risk management system, according to embodiments of the present technology.

FIG. 3 illustrates an example of a flow diagram illustrating a process used by the risk management system, according to embodiments of the present technology.

FIG. 4 illustrates an example of a decision structure for a multi-period integrated switching simulation, according to embodiments of the present technology.

FIG. 5 is an example of a flow chart showing a process for implementing a multi-period integrated switching simulation, according to embodiments of the present technology.

FIG. 6 is an example of a flow chart showing a process for adjusting data based on the implementing of a multi-period integrated switching simulation, according to embodiments of the present technology.

FIG. 7 is an example of aflow chart showing a process for implementing a multi-period integrated switching simulation, according to embodiments of the present technology.

FIG. 8 is an example of a table with data for a base risk model risk profile, including value at risk (VaR) and expected shortfall (ES) risk over a risk horizon of a certain number of days, according to embodiments of the present technology.

FIG. 9 is an example of a graph of a base risk model risk profile, including VaR 99.9% and ES 99.9% risk measures over a risk horizon of a certain number of days, according to embodiments of the present technology.

FIG. 10 is an example of a graph of a base risk model risk profile, including terminal portfolio profit and loss distribution, according to embodiments of the present technology.

FIG. 11 is an example of a table with data for a rare event risk model risk profile, including VaR and ES risk over a certain number of days, according to embodiments of the present technology.

FIG. 12 is an example of a graph of a rare event risk model risk profile, including VaR 99.9% and ES 99.9% risk measures over a risk horizon of a certain number of days, according to embodiments of the present technology.

FIG. 13 is an example of a graph of an event risk model, including terminal portfolio profit and loss distribution, according to embodiments of the present technology.

FIG. 14 is an example of a table with data for a switching simulation risk model risk profile, including VaR and ES risk over a certain number of days, according to embodiments of the present technology.

FIG. 15 is an example of a graph illustrating a switching model, including VaR 99.9% and ES 99.9% risk measures over a risk horizon of a certain number of days, according to embodiments of the present technology.

FIG. 16 is an example of a graph illustrating a Markov switching model, including VaR 99.9% and ES 99.9% risk measures over a risk horizon of a certain number of days, according to embodiments of the present technology.

FIG. 17 is an example of a graph illustrating a switching simulation risk model, including terminal portfolio profit and loss distribution, according to embodiments of the present technology.

FIG. 18 is an example of an illustration of is a graph illustrating a Markov switching simulation risk model, including terminal portfolio profit and loss distribution, according to embodiments of the present technology.

### DETAILED DESCRIPTION

Embodiments of the present technology include various techniques and systems for evaluating risk in an entity. Specifically, techniques and systems are provided for a multi-period integrated switching simulation (e.g. integrated simulation with switch algorithm) that combines risk simulation with integrated risk stress testing. For example, the simulation integrates rare stress events and model stress into historical risk simulation models. The multi-period integrated simulation with switch algorithm incorporates plausible events that are not necessarily captured in historical data or in historical stressed calibration of risk models. The integrated system risk model framework leads to forward-looking risk (e.g., tail risk) measurement.

Historically, historical data and stress testing have been viewed and used as relevant for separate types of analysis in modern risk analysis. A goal of stress testing is to capture forward-looking loss distribution, including potential scenarios that may not have occurred in the past. Therefore, it may not be beneficial to view and use stress scenarios and historical financial data in separate analyses. Instead, a stress testing model and stress scenarios may be integrated into a computer-implemented model that also includes past financial data to yield a single, comprehensive risk analysis model that works over multiple periods.

As described in this disclosure, a computerized system uses various models and simulation techniques to inform risk management decision making. Embodiments of the system access a rich supply of historical data related to various factors that may affect a bank's financial (e.g. cash flow, income, profit, loss, capital, etc.) situation. For example, the factors may include cash flow effects related to any of the bank's assets or liabilities. The factors may also include, for example, the interest rate at which the bank can borrow money, and any other factor that may affect the bank's solvency.

Embodiments of the system may analyze a bank's current balance sheet and projects cash outflows (cash flow impacts) that may be incurred by the bank in the event of many different hypothetical scenarios. More specifically, embodiments of the system use the historical data to model how changing economic and financial circumstances have interacted with the factors that affect the bank's financial (e.g. cash flow, income, profit, loss, etc.) situation. An embodiment of the system uses the historical data in conjunction with a simulation engine that generates randomized simulation paths that represent future economic developments (of equal or weighted probabilities). The simulation paths are represented as hypothetical future changes in economic, banking, credit, and political circumstances during particular periods of time. Based on the historical interactions between these circumstances and the various components of the bank's financial situation (e.g. cash flow), an embodiment of the system may assign period-by-period cash flow impacts to each simulation path. In this process, an embodiment of the system determines a different cash flow impact for each time period of each simulation path.

A simulation engine may produce thousands of different scenarios that represent future economic developments (of equal or weighted probabilities), and therefore may not put enough (or any) added stress on certain scenarios that may be cause more drastic effects on the bank and its financial situation or balance sheet. Certain examples of the disclosed system integrate the scenarios with a complementary risk analysis tool, stress testing, so that such scenarios are emphasized. More specifically, an embodiment of the system may incorporate unlikely, but plausible, events that may not be captured in simulations including only historical-based simulations. The rare stress testing events are captured by using one of a variety of switching simulations integrated with historical data based simulations.

The switching simulation incorporates both event stress and model stress, as well as mixtures of the two. Event-based multi-period stress is added to a base model (e.g., an equity portfolio) and the complete risk distribution—integrating the base model and the stress events—is obtained. Model-based stress includes a switching function to drive the covariance matrix such that model correlation parameters can change. Examples of the method are also applicable to various financial risk models such as, for example, integration of rare stress events and model stress into a market risk portfolio. Another example includes portfolio credit risk models where forward-looking events or model stress can be imposed on the multifactor models for firms' returns and rating migrations. Within embodiments of the present technology, both event-based stress and model-based stress, or mixtures of the two, may be incorporated into the risk analysis framework described herein.

Furthermore, the integration of historical simulations and stress testing are captured across multiple (e.g., several or many) different periods of time. For example, if an integrated simulation and stress testing model have a period unit of one month, then the integrated model may extend across multiple months. Furthermore, each period may have an effect upon its following period. More specifically, if a stress test scenario occurs at a certain probability in a first period of the model, then that occurrence may have an effect on the probability that that same stress test scenario may occur in a second period of the model that occurs directly after the first period of the model. For example, consider an example where the three possible stress test scenarios are those designated by the Federal Reserve, baseline, adverse, and severely adverse. If, in a first period, the probability of an adverse stress test scenario occurring is 90%, then the probability of an adverse stress test scenario occurring in a second period (after the first period) may be greater than 90% (or at least may be greater than the chances of a baseline or severely adverse stress test scenario occurring). Similarly, if, in a first period, the probability of a severe adverse stress test scenario occurring is 2%, then the probability of a severe adverse stress test scenario occurring in a second period (after the first period) may be less than 2% (or at least may be less than the chances of a baseline or adverse stress test scenario occurring).

Based on these projections, an embodiment of the system may structure a portfolio that is forecast to provide matching cash flows in a manner that satisfies a mismatch tail risk criteria specified as a minimum percentage of the scenarios that the bank may withstand. In other words, an embodiment of the system may choose assets in the portfolio so that the probability that the portfolio will provide offsetting cash flows throughout the planning horizon exceeds the tail risk criteria. The portfolio may be structured to provide liquidity coverage in a majority of hypothetical economic situations that may come to fruition. But, if a primary portfolio is designed to provide liquidity coverage in all hypothetical scenarios, it may be overly secure and the bank holding the portfolio may lose opportunity to generate profit.

Certain aspects and features of embodiments of the system may also provide optimization capabilities and features that process information about a bank's balance sheet to identify the portfolio allocation expected to realize the highest profit in a manner that also satisfies the cash flow matching condition. An embodiment of the system may utilize complementary methods of finding an optimal portfolio that will satisfy regulatory requirements by providing counterbalancing capacity that is sufficient for the bank to be able to remain solvent in at least a specified percentage of stress testing simulation scenarios.

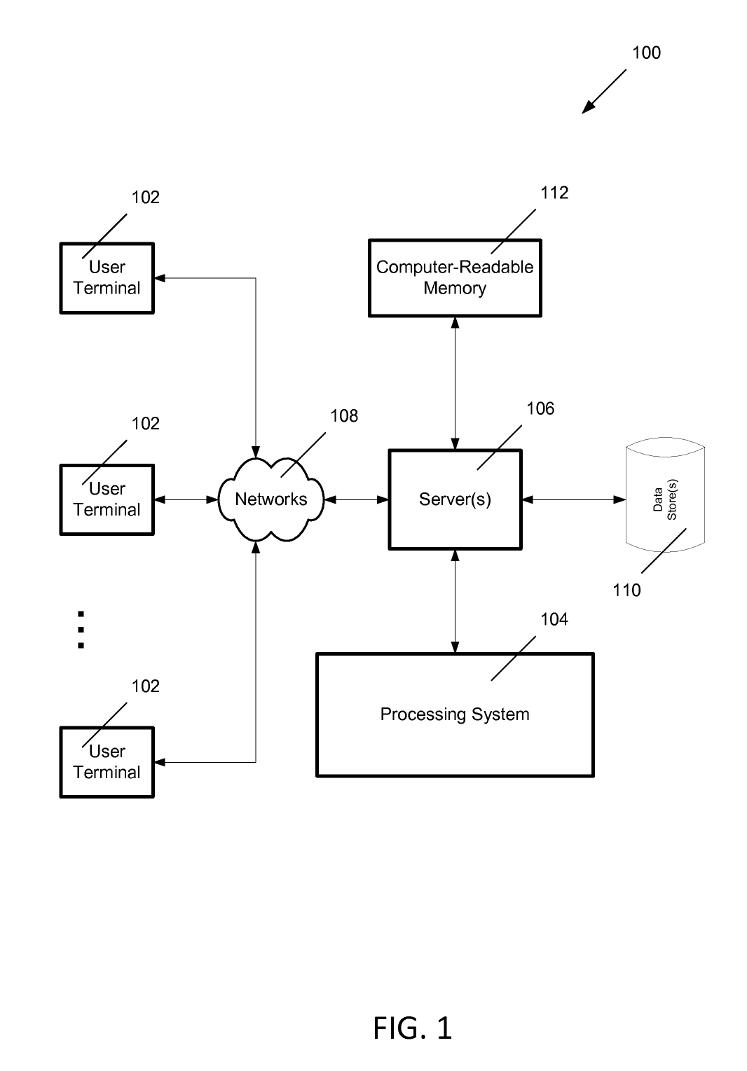

FIG. 1 illustrates a block diagram that provides a generalized illustration of hardware and software components of a risk management system 100, according to embodiments of the present technology. More specifically, risk management system 100 includes a computer-implemented environment where user terminals 102 can interact with a processing system 104 (including, e.g., data processing apparatus) hosted on one or more servers 106. An embodiment of the system 104 may contain software operations or routines. The users' terminals 102 can interact with the system 104 through a number of ways, such as, for example, over one or more networks 108. One or more servers 106 accessible through the network(s) 108 can host the system 104. The system 104 may also be provided on a stand-alone computer for access by a user.

The server 106 uses an input/output capability (e.g., where user terminals 102 may connect to the system) to store and retrieve data from data store 110. Data store 110 is used to store data used by an embodiment of the system including the results of various simulations stress tests over time. This data includes a wide variety of historical financial and economic data, as well as information about the bank's balance sheet and business environment that can be inputted by a user. The data store 110 may also hold recent and historical data about credit markets, the economy and the financial status of the bank's customers. More specifically, the economic data may include historical time series data with regard to economic variables such as oil prices, unemployment, stock market performance, GDP, tax revenues, inflation, Treasury rates, etc. The data may also include information related to default rates and performance of various classes of bonds, equity, real estate and other investments available to the entity or bank that is using the risk management system. This performance information details historical changes in these instruments at various times for which economic data is available. The data store 110 may also include historical data related to the entity. The entity data can be in the form of time series data or correlation data, or both. Entity data depicts the historical changes in the bank's negative and positive data (e.g., cash flow) throughout its history. For example, the entity data shows changes in the bank's depositor withdrawal rate, new deposits, and changes in cash flows attributable to imbedded optionality, as well as other forms of obligations. When the entity data is stored in the form of correlation data, the correlation data may indicate the correlation between the various forms of negative cash flow and other variables tracked within the data store. For example, the correlation data may include historical correlation of the deposit withdrawal rate with GDP, as well as with the price of oil, the unemployment rate and any of the other variables tracked in the data store 110.

When a simulation is executed, an embodiment of the system may output a graphical display (not depicted) of the simulation results. The system 100 may output the display by using network 108 to download display data and executable code from server 106 so that the data and code may be executed or processed at any of the user terminals 102. The server 106 may include or be connected to any number of processors (e.g., processing system 104), any number of which may be multi-threaded. The servers 106 also include or be connected to a memory (e.g., computer-readable memory 112) or software.

The risk management system 100 may use the economic and investment data in the data store 110 to compute correlations between economic variables and the cash flows of the various investments and instruments available to the bank. The system 100 may also use the economic and investment data in the data store 110 to compute correlations between economic variables and the various categories of outgoing cash flow (or other aspects of the entity's financial situation) demands that the bank can face. By computing these many correlations, the risk management system 100 may also be able to randomly generate multitudes of simulated economic scenarios as part of its scenario analysis. Embodiments of the present technology integrate stress testing into these simulated economic scenarios to create a multi-period switching simulation, as described herein.

There are two types of models related to integrated stress testing according to the various embodiments of the present technology. The first type of model includes classical risk models that are calibrated based on historical data collected over time (past behavior of financial data). The second type of model includes forward-looking hypothetical models (stress testing). Stress events may represent future economic states, and should therefore be a factor in the risk management system.

The forward-looking hypothetical models also may or may not be based on historical (past) events or other information. For example, forward-looking hypothetical models may be based on events that have happened in the past, may happen again, and are simulated for possible future reoccurrence. In another example, forward-looking hypothetical models may be based on events that have never happened before but may happen in the future.

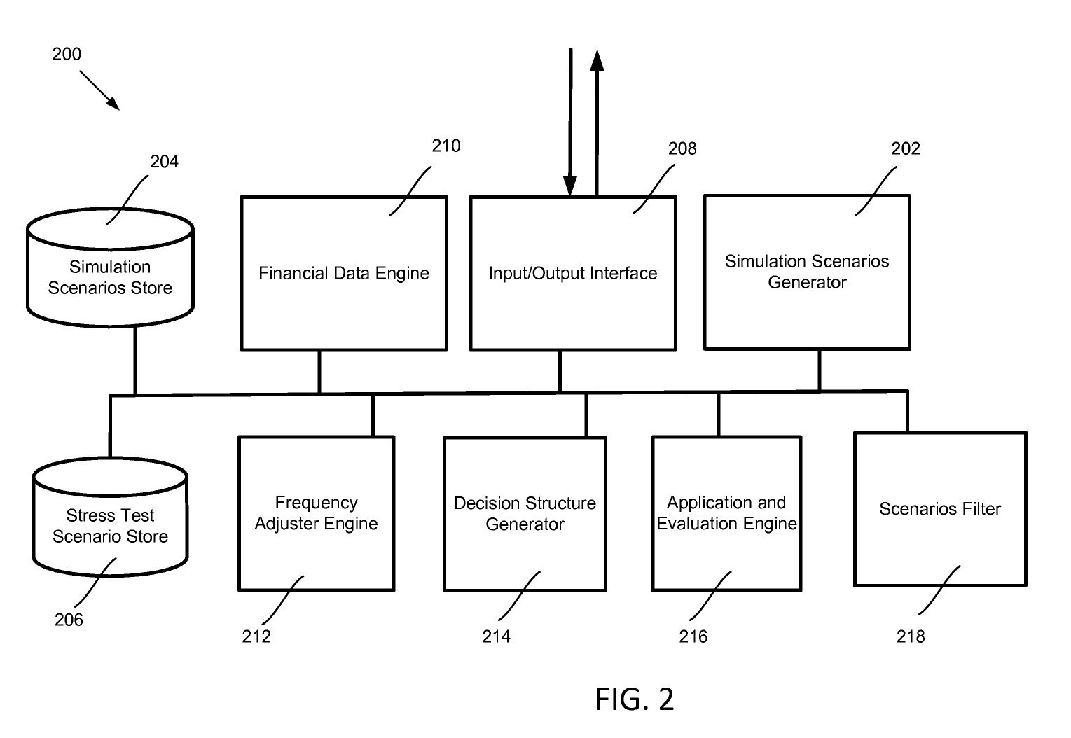

FIG. 2 illustrates a block diagram bus that provides a generalized illustration of hardware and software components of a risk management system 200, according to embodiments of the present technology. The risk management system 200 may include various engines and other components. For example, risk management system 200 may include a simulation scenarios generator 202. Simulation scenarios generator 202 may generate a number of scenarios, or randomized simulation paths that represent equally probable future economic developments. The simulation scenarios generator 202 may generate any number of simulations (either predetermined by a user, or randomized). For example, the simulation scenarios generator 202 may generate one-hundred, one-thousand, ten-thousand, or any other number of simulated scenarios. The simulated scenarios may be based on historical data compiled over a (e.g., long) period of time, and represent hypothetical future changes in economic, banking, credit, and political circumstances during particular periods of time. For example, the scenarios may be compiled based on various events that occurred in the past. As noted, the generated scenarios may be applied to the portfolio of an entity to determine all or a subset of the possible outcomes (e.g., events) that may occur in the future given the current state of the portfolio, and an estimated probability of those outcomes occurring in the future. During and after such simulations are generated, they may be stored in simulation scenarios store 204. However, the simulation scenarios generated by simulation scenarios generator 202 may also be stored in various other locations within risk management system 200, either in temporary or permanent storage devices.

However, such an application may place the same or similar emphasis on each possible outcome or event. Therefore, when applying the simulation scenarios to the portfolio by themselves, a scenario that may have no or little effect on the financial situation (e.g. cash flow) or portfolio of the institution may be weighted or emphasized the same or a similar amount to a scenario that may have a significant impact on the financial situation (e.g. cash flow) or portfolio of the institution. In other words, the simulation engine, by itself, may not be sufficient in certain circumstances to accurately model future changing economic and financial circumstances.

Risk management system 200 may also include an input/output interface 208. The input/output interface 208 may be configured to process instructions that are used to solicit and obtain from a user the various inputs, parameters and constraints used by the models. Furthermore, input/output interface 208 may be configured to store and retrieve data from other parts of the system to transmit to a user, or to an external device. For example, the input/output interface 208 may output a graphical display of simulation results generated by the simulation scenarios generator 202. Simulation scenarios generator 202 is configured to allow a user to interact with or control the risk management system 200.

Risk management system 200 may also include a stress test scenario store 206. Stress test scenarios may, for example, be generated by a stress test scenario generator (not shown), similar to simulation scenarios generated by the simulation scenarios generator 202. However, stress test scenarios may also be received by the system from other sources, such as, for example, from a user via the Input/Output Interface 208. For example, stress test scenarios may be inputted into the system by a user and thereafter stored by stress test scenario store 206. Stress test scenarios may be entered by a user due to requirements developed internally within the bank, or may be designated as regulations or requirements by a government agency, such as the federal government. As such, stress test scenario store 206 may receive stress test scenarios, which may consist of extreme scenarios that reflect the rare possibility of severe loss to the institution, and store those scenarios for use by the risk management system.

Risk management system 200 may also include a financial data engine 210. Financial data engine 210 may receive or generate data that may be used within the risk management system to obtain measurements of future risk, including risk related to hypothetical future changes in economic, banking, credit, and political circumstances during particular periods of time. For example, the economic data may include historical or current time series data with regard to economic variables such as oil prices, unemployment, stock market performance, GDP, tax revenues, inflation, Treasury rates, among others. The data may be automatically or dynamically updated as new financial data is collected as time periods (e.g., future time periods) occur and pass by. This data may be retrieved by stimulation scenarios store 204 to help generate simulation scenarios therein, or may be used in conjunction with simulation scenarios (and stress test scenarios) to contribute to an integrated system risk model framework that leads to forward-looking risk (e.g., tail risk) measurement, as described herein.

Risk management system 200 may also include a frequency adjuster 212. Frequency adjuster 212 may receive inputs from several different portions of the risk management system. For example, frequency adjuster 212 may receive inputs in the form of simulation scenarios (e.g., from simulation scenarios store 204 or from a user via input/output interface 208), stress test scenarios (e.g., from stress test scenario store 206 or from a user via input/output interface 208), and financial (or other) data (e.g., from financial data engine 210 or from a user via input/output interface 208). However, different portions of the received data may be presented with incompatible time periods or frequencies. For example, the generated simulation scenarios may be presented as a certain percentage over a period of one month (or multiple periods of multiple months), while the received stress test scenarios may be presented as a certain percentage over a period of one quarter of a year (or multiple periods of multiple quarters). The frequency adjuster 212 may be configured to adjust one or more of the data sets so that the different sets of data are compatible and may be easily combined or compared. The frequency adjuster 212 may adjust the frequency of the simulation scenarios to match the frequency of the stress test scenarios, the frequency of the stress test scenarios may be adjusted to match the frequency of the simulation scenarios, or the frequency of both the simulation scenarios and the stress test scenarios may be adjusted to match a frequency different than the frequency of either the simulation scenarios and the stress test scenarios (e.g. to a desired analysis frequency, which the user desires to use as the frequency for the decision structure.

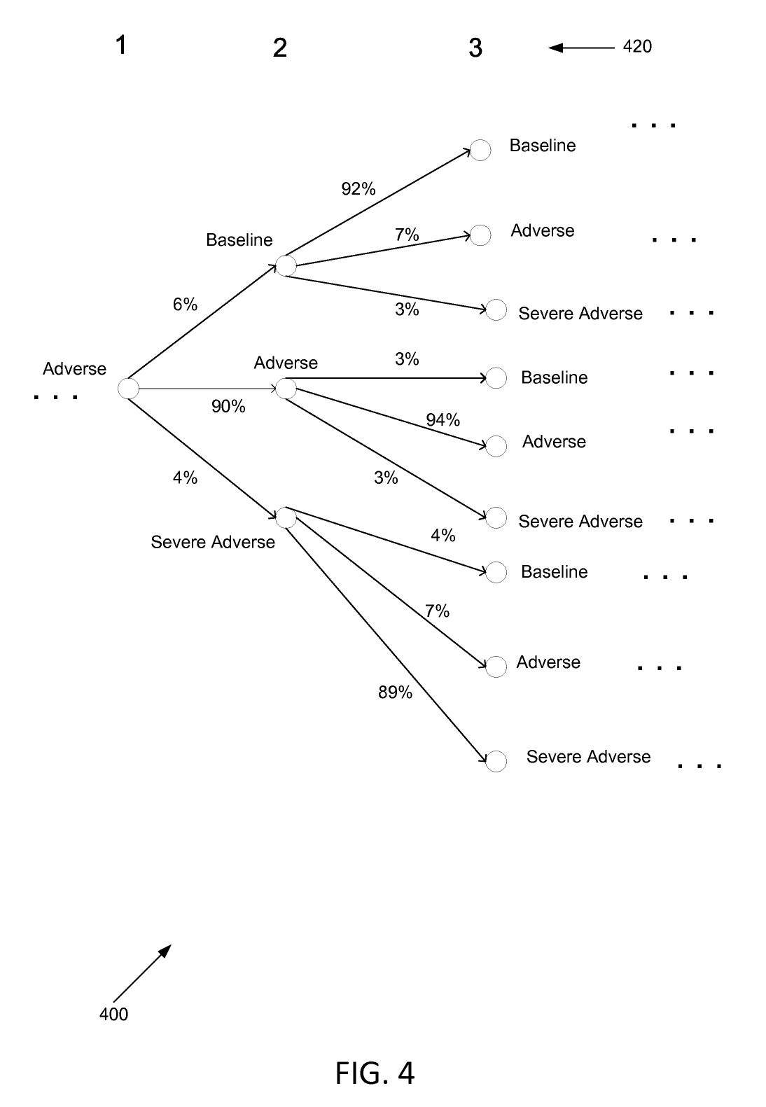

Risk management system 200 may also include a decision generator 214. The decision generator 214 may, after frequency adjuster 212 adjusts (or refrains from adjusting) the frequency/period of the data (e.g., simulations), generate a decision structure, or a series of decisions based on the simulations, stress test scenarios, and time horizon. The decision structure may include hypothetical future decisions of the integrated simulation with switch algorithm, according to embodiments of the present technology, for each of multiple periods of time in the future. An example decision structure, which may be generated by the decision generator 214, is shown in FIG. 4, and will be described further with respect to FIG. 4.

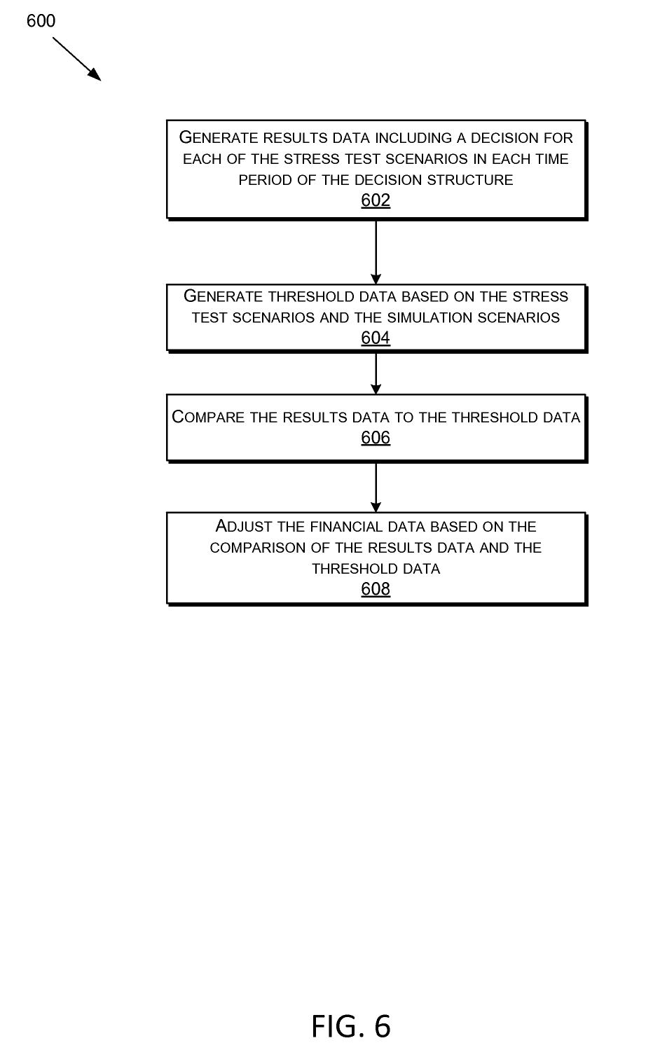

The decision generator, such as decision generator 214, may use multiple different approaches (e.g. rules) in integrating the simulation scenarios and stress test scenarios to make its decisions regarding which scenario will occur at each (and each subsequent) time period. First, the decision generator may use a chain or decision structure/tree (e.g. a transition probability matrix) to determine the probability given to the current state at a horizon and how likely the next horizon state is to remain at that state or to change to a different state (e.g. that a given stress test scenario will be applied at that horizon). An example decision structure is described further with respect to FIG. 4. Second, the decision generator may use a threshold-based approach. This approach relies on the realized value of one or more indicator variables at the current or past horizon(s)to determine what will happen at the next horizon. An example approach or process is described below with respect to FIGS. 4 and 6.

Risk management system 200 may also include an application and evaluation engine 216. The application and evaluation engine 216 may apply (e.g. run simulations for multiple periods based on) the decision structure, which was, for example, generated by the decision generator 214, to a portfolio of an entity. More specifically, the risk management system 200 may use the results of the application of the decision structure to the portfolio to analyze and determine the risk associated with the portfolio. For example, the bank may determine, based on the results, whether the bank has enough cash flow on hand to account for the risk assigned to the portfolio during each period of time in the future.

Risk management system 200 may also include a scenarios filter 218. Scenarios filter 218 may, upon receipt of an input or generation of stress test scenarios, may filter out certain scenarios to prevent those scenarios from being considered during implementation of the risk management system and in the optimization that determines the allocation of assets in the contractual assets portfolio. For example, the scenarios filter may be or include an extreme scenarios filter that eliminates a portion of the set of scenarios that are deemed to be extreme scenarios. The number or percentage of scenarios eliminated in this process may be dictated by inputs from the user or may be set as a setting by the user. An example of a scenarios filter 218 will be discussed further with respect to FIG. 4.

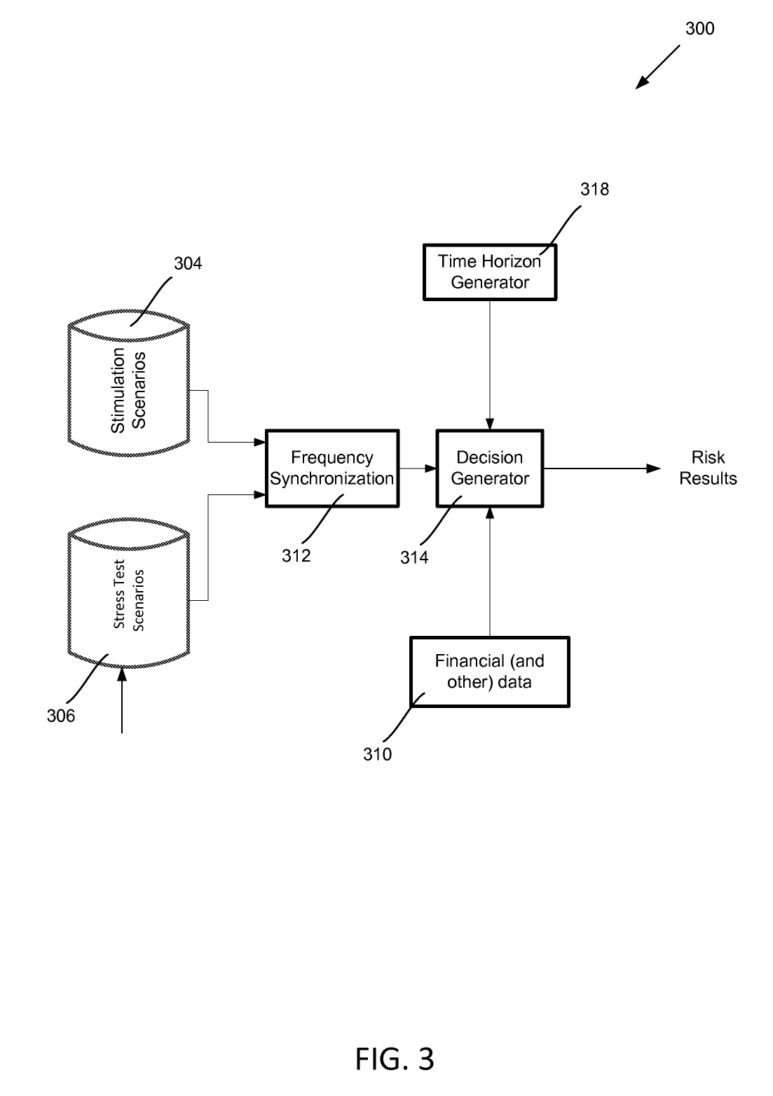

FIG. 3 illustrates a flow diagram 300 illustrating a process used by the risk management system, according to embodiments of the present technology. Simulation scenarios and stress test scenarios can be generated or received and stored at simulation scenarios 304 and stress test scenarios 306, respectively. For example, as noted, simulation scenarios may be generated by a simulation scenario generator. Alternatively, stress test scenarios may be inputted by a user.

The simulation scenarios 304 may be considered to be a “base” model, or the historical data or set of historical simulations that are the base for the multi-period switching model applied within embodiments of the present technology. In other words, the base model is the model that may be modified, using the stress test scenarios, to create the multi-period, forward-looking switching model described herein. The base model, or simulation scenarios, is generated or predefined before being adjusted or combined with the stress test scenarios.

The simulation scenarios and stress test scenarios are then synchronized at box 312. The simulation scenarios and stress test scenarios may not have the same frequencies, and therefore may be difficult to combine to be used in a single model. Therefore, the frequencies (or periods) of the simulation scenarios and stress test scenarios are synchronized so that the simulation scenarios and stress test scenarios can be combined into a single switching simulation. For example, if one of the two sets of scenarios has a period of 1 month and the other set of scenarios has a period of 3 months (one-quarter of a year), then the frequency synchronization may adjust one of the two sets of scenarios so that that set of scenarios has the same period as the other set of scenarios. In an alternative embodiment, both sets of scenarios may be adjusted so that they have a different period than the two periods that the sets of scenarios originally had.

Other data used to synchronize the frequencies of the scenarios may be a time horizon or series of time horizons, which may be inputted or specified by a user, or generated by a time horizon generator, at box 318. The time horizon may be limited to one or two months, or may be as long as three or more years. The time horizon determines for how far out in time the risk simulation model will project risk. If, for example, the time horizon is three years and the simulation period is one month, then the simulation will run for thirty-six periods. On the other hand, if the time horizon is three years and the simulation period is one quarter of one year, then the simulation will run for twelve periods. After the decision structure is applied, one or more risk measurements may be outputted from the system for the portfolio or balance sheet of an entity. The results, after application of the decision structure, may include a decision for each of the scenarios at each period of the decision structure.

After the frequencies of the simulation scenarios and stress test scenarios are synchronized, a decision generator makes a set of decisions (i.e. a decision structure), at box 314. The decision generator in box 314 may use a switching function to decide which model (e.g., the historical simulation scenarios or the stress test scenarios, or which stress test scenario within the set of stress test scenarios) the replications should be drawn from. For example, the switching function may make such choices based on a variety of conditions. The conditions may take many forms, including exogenous or endogenous conditions. The conditions, and whether one or more of those conditions are met, determine which scenario or result applies to the node within the current period of the decision structure. An example decision structure result is shown in FIG. 4 and described further with respect to FIG. 4. For example, the decision generator 314 may integrate the data it receives to decide whether a simulated path (e.g. simulation scenario) or a stress path (e.g. stress test scenario) should be used in the following analysis step (e.g. time horizon).

Other data may also be used to generate such a structure (e.g. to generate such decisions), including financial or other data, received from box 310. The data may include historical or current data with regard to one or more of various economic variables such as oil prices, unemployment, stock market performance, GDP, tax revenues, inflation, Treasury rates, among others.

After the decision structure is applied to an organization's portfolio, the results of the decision structure as applied to the portfolio may be analyzed to determine if the determined future risk as outlined by the risk management system warrants any changes to the portfolio. Such analysis may be performed by the evaluation engine 216, as described with respect to FIG. 2. To determine if the risk is, for example, too high, a threshold or a set of threshold data may be generated and compared to the results. The set of threshold data may be predetermined as a set of data designated as the most extreme data allowed or desired based on the inputted stress test scenarios. If the resulting data from the applied data structure exceeds the threshold data, then the financial data may be adjusted. Such adjustments may cause the decision structure, when applied to the adjusted financial data or portfolio, to yield results that do not exceed the threshold data. For example, the threshold(s) or threshold data may be in the form of percentages. However, the threshold(s) or threshold data may be in other forms as well. For example, the threshold(s) or threshold data may be a number or set of numbers that are of the same unit of measurement as the result that the threshold(s) or threshold data is being compared to. For example, the threshold may include a number of points in the stock market (e.g. the Dow Jones Industrial Average) such that a reset is due if/when the result crosses that number of points.

FIG. 4 illustrates a decision structure 400 for a multi-period integrated simulation with switch algorithm, according to embodiments of the present technology. The decision structure 400 is generated by time period, as shown by periods 420. Periods 420 include periods 1, 2 and 3. Each period includes, as shown in the decision structure 400, a set of hypothetical scenarios. Each hypothetical scenario is assigned a probability. Each hypothetical scenario is based, at least in part, on the scenario that it resulted from (in the period just before the period that the current scenario takes place within).

Decision structure 400 includes, for example, a period 1. Although period 1 is named “period 1” for purposes of this example, period 1 may not be the first period in a different model. For example, other periods (of time) may have come before period 1, and the previous periods may have contributed to the hypothetical scenario in period 1.

In the example of FIG. 4 and decision structure 400, the stress test scenarios utilized are the supervisory stress test scenarios designated by the Federal Reserve. For example, the stress test scenarios may be received from the Federal Reserve or from a user input (e.g. via user terminals 102). The three possible stress test scenarios, as designated by the Federal Reserve are: baseline, adverse, and severely adverse. These hypothetical scenarios designed to assess the strength of banking organizations and their resilience to an adverse economic environment. For example, the severely adverse scenario is characterized by a substantial weakening in economic activity across all of the economies included in the scenario. Furthermore, the severely adverse scenario features a significant reversal of recent improvements to the U.S. housing market and the Euro area outlook. The adverse scenario is characterized by a weakening in economic activity across all of the economies included in the scenario, combined with a global aversion to long-term fixed-income assets that brings about rapid rises in long-term rates and steepening yield curves in the United States and in the four countries or country blocks (the Euro area, the United Kingdom, developing Asia, and Japan) represented in the scenario. The baseline scenario follows a contour similar to the average projections from surveys of various economic forecasters. The adverse scenario represents a hypothetical scenario that may cause more severe loss than, for example, the baseline scenario. The severe adverse scenario represents a hypothetical scenario that may cause more severe loss than, for example, either the adverse scenario or the baseline scenario. Although the examples described herein use the stress test scenarios provided by the Federal Reserve, using other stress test scenarios (either generated within the system or inputted by a user) is also considered to be within the scope and embodiments of the present technology.

In this example decision structure 400, period 1 includes one hypothetical scenario. The scenario at period 1 was determined to be an “adverse” scenario. When moving from period 1 to period 2, the decision structure 400 includes the different probabilities that the adverse scenario in period 1 transitions in period 2 to each of the three different possible stress test scenarios, adverse, baseline, or severe adverse. As shown in FIG. 4, the decision structure 400 shows that, in this example, there is a 90% chance that the scenario in period 2 remains as an adverse scenario, a 6% chance that the scenario in period 2 switches to a baseline scenario, and a 4% chance that the scenario in period 2 switches to a severe adverse scenario. Similar transitions are shown from each of the scenarios in period 2 to each of the three different possible stress test scenarios, adverse, baseline, or severe adverse. As such, the integrated simulation with switch algorithm according to embodiments of the present technology is multi-period, or in other words may project risk measurement over multiple periods.

The switching methodology utilized in decision structure 400 is configured so that any scenario may have an effect on the scenarios in the period that follows. For example, the adverse scenario in period 1 may cause the probability of the adverse scenario occurring in period 2 to be at a very high percentage (e.g., 90%, as shown in period 2). As such, the switching methodology implemented by the decision structure 400 includes “switching” from stress scenario to stress scenario within each simulation based on various factors, including the existing and historical financial data and, for example, the assigned stress scenario for that path during the previous period. However, a variety of other causal effects may take place from period to period and from scenario to scenario between those periods.

Each path within the decision structure 400 represents a different possible scenario for a given period. The structure may be used to generate a set of simulations that may be applied to a portfolio of a financial or other institution to assess the future risk of that institution. The structure may use the scenarios and the weights within the structure to determine whether a stress test scenario will occur based on the data within the portfolio.

As noted, the risk management system described herein may also include a scenarios filter (e.g. scenarios filter 218) that may, upon receipt, input or generation of stress test scenarios, may filter out certain scenarios to prevent those scenarios from being considered during implementation of the risk management system and in the optimization that determines the allocation of assets in the contractual assets portfolio. For example, the scenarios filter may be or include an extreme scenarios filter that eliminates a portion of the set of scenarios that are deemed to be extreme scenarios. The number or percentage of scenarios eliminated in this process may be dictated by inputs from the user or may be set as a setting by the user. These types of settings may also be included in a stress test scenario target parameter that represents a level of portfolio liquidity shock resistance that is targeted, and is based on the bank's risk appetite and regulatory requirements. The higher the bank's appetite for risk, the greater is the number of scenarios that will be eliminated by the extreme scenarios filter. Due to the filter, the portfolio may be expected to suffer negative cash flows that are not counterbalanced, in the event that any of the eliminated scenarios actually come to fruition. The remaining scenarios after the filter is implemented may be stored (or the stored set of scenarios may be updated) within the stress test scenario store (e.g., stress test scenario store 206 described with respect to FIG. 2).

The scenarios filter may be dynamically customized or predetermined based on certain settings from the user. For example, the user may want to keep certain extreme scenarios and not others, or may want to keep all extreme scenarios but eliminate less extreme scenarios.

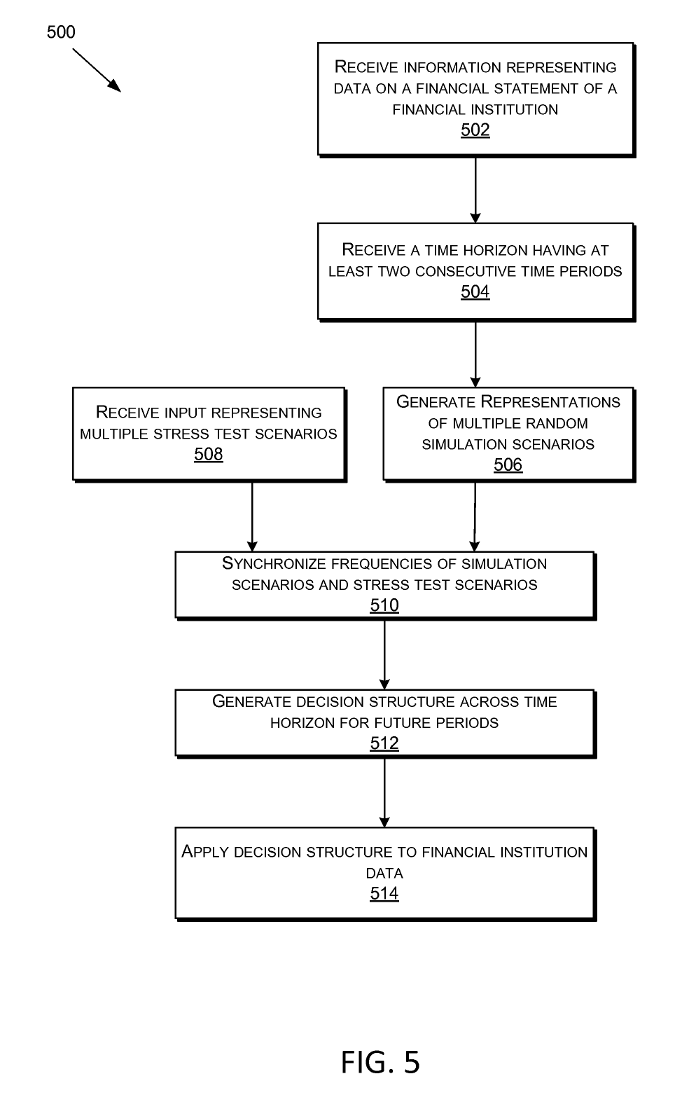

FIG. 5 is a flow chart 500 showing a process for implementing a multi-period integrated simulation with switch algorithm, according to embodiments of the present technology. Operation 502 includes receiving information representing data on a financial statement of an entity. This financial information/data may be any of a variety of data related to the financial situation of a financial (or other) institution. For example, the financial data may include information related to a portfolio of the institution, the assets of the institution, the cash flow or balance sheet of an institution, among others related to the financial situation of the entity. This financial data may be historical data related to events that happened in the past, and may be the basis for simulation scenarios based on that historical data.

Operation 504 includes receiving a time horizon having at least two consecutive time periods. As noted, the multi-period integrated simulation may forecast, in a forward-thinking approach, one or more periods of time. The probabilities or other results generated for one period may have a causal effect on the next and subsequent periods.

Operation 506 includes generating representations of multiple random simulation scenarios. These randomized simulation scenarios may be based on the received financial data in operation 502. However, various other factors may contribute to the simulation scenarios generated in operation 506. For example, various external factors may contribute. Such factors may include economic variables such as oil prices, unemployment, stock market performance, GDP, tax revenues, inflation, Treasury rates, etc. The scenarios are generally based on historical data and therefore are based primarily on past events. The multi-period integrated simulation described herein combines these simulations with a forward-based model so as to cover most or all possible events, both stress-based and otherwise. In other words, rare stress testing events are captured by using one of a variety of integrated switching simulations integrated with historical data based simulations.

Operation 508 includes receiving input representing multiple stress test scenarios. The stress scenarios/events are integrated with historical-based simulation scenarios by the system receiving such stress scenarios. The stress scenarios may be received from a variety of different entities. For example, a user may input the stress scenarios that the user may like to capture in the model. In another example, an embodiment of the system may receive such scenarios from the Federal Reserve or the Federal Reserve stress test scenarios may be inputted by a user or another third party. The stress test scenarios are rare events that, when combined or combined with historical simulation scenarios, can create a model that may account for most or all possible simulations/situations.

Operation 510 includes synchronizing the frequencies of the simulations scenarios and stress test scenarios. After both the historical simulations and stress based scenarios are received, the two types of information are synchronized. For example, the stress scenarios and simulation scenarios may have different periods/frequencies. Therefore, in order to efficiently combine the two types of scenarios, they may be adjusted so that they are on the same frequency.

Operation 512 includes generating a decision structure across the received time horizons (e.g., two or more consecutive time periods). Each period within the decision structure includes a set of hypothetical scenarios. Each hypothetical scenario is assigned a probability. Each hypothetical scenario is based, at least in part, on the scenario that it resulted from (in the period just before the period that the current scenario takes place within). The base scenario, from which the multi-period integrated simulation builds off of and from where the decision structure starts, may include the aforementioned historical simulation scenarios model. An example decision structure is described further with respect to FIG. 4.

Operation 514 may include running simulations, using a decision structure, to entity data (e.g. a portfolio) in order to achieve a resulting risk measurement for that entity data. For example, a portfolio of an entity may be analyzed using the generated decision structure so as to generate a risk probability for each node within each period of the decision structure for the entity data being analyzed. In other words, the decision structure may yield a risk model specified to the specific financial information associated with the entity being analyzed.

FIG. 6 is a flow chart 600 showing a process for adjusting financial data based on the implementing of a multi-period integrated simulation, according to embodiments of the present technology. Operation 602 includes generating results data including a decision for each of the stress test scenarios in each time period of the decision structure. This operation is similar to operations 512 and 514 of flow chart 500. After a decision structure is generated, including historical simulation scenarios and stress test scenarios, that decision structure is applied to a portfolio of an entity, or more generally to financial or other data of an institution. In other words, a probability or other risk-related results may be generated for each node of each period within the decision structure based on the portfolio or other data of the institution being analyzed.

Operation 604 includes generating threshold data based on the stress test scenarios and the simulation scenarios. In other words, thresholds are generated to reflect a maximum or minimum or other threshold related to the risk tolerance that the bank may choose to abide by. In other words, the bank (or an outside entity) may set thresholds based on the bank's tolerance for risk related to each stress situation.

Operation 606 includes comparing the results data to the threshold data. The results data received after the decision structure is applied to the financial data of the institution, or in other words the results of the probabilities that each stress scenario occurs based on the financial data of the institution, may be compared to the set (e.g., predetermined) thresholds of risk tolerance.

Operation 608 includes adjusting the financial data based on the comparison of the results data and the threshold data. The results of the comparison of the results data and the threshold data may indicate to a user whether the current financial data creates a scenario that, as a whole, is too risky for the bank. If the results exceed the set thresholds, the financial data, such as for example assets included in a portfolio, may be adjusted to account for that higher than desired risk. In other words, the portfolio may change (e.g., sales, buys) to make the portfolio less risky.

In another embodiment, FIG. 6 is an example flow chart that describes adjusting financial data based on the implementing of a multi-period integrated simulation using thresholds to determine a result for each of two or more time horizons. For example, the process may begin with a simulation generator and one or more stress scenarios each associated with a thread. A simulation may be run for a first horizon on each simulation path. Next, the simulation may be checked to determine if the first horizon realization crossed a predetermined threshold (can be either a floor or ceiling threshold). If the threshold is crossed, then the stress scenario may be applied. The process continues with a next (second) horizon based on the simulation model and the threshold based scenario and the second horizon realization may be checked to determine whether another stress scenario or the regular simulated result should be applied. The process may include as many horizons as desired.

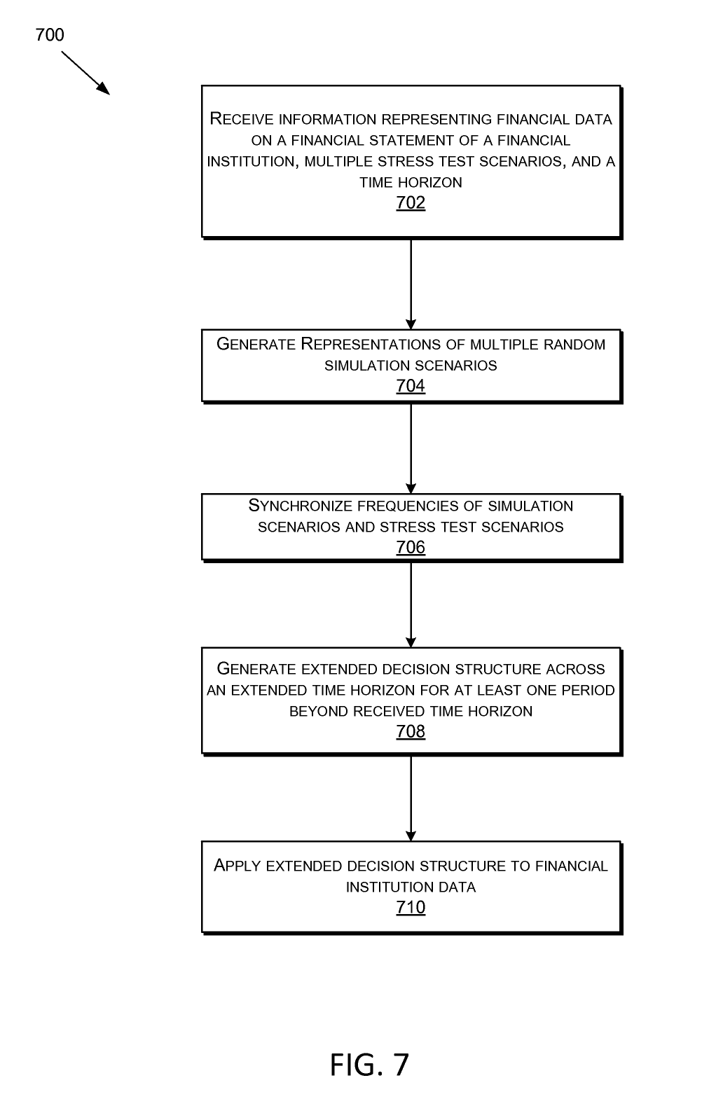

FIG. 7 is a flow chart 700 showing a process for implementing a multi-period integrated simulation with switch algorithm, according to embodiments of the present technology. Flow chart 700 includes a process that is similar to the process included in flow chart 500, but for extended periods beyond the received time horizon. Operation 702 includes receiving information representing financial data on a financial statement of an entity, multiple stress test scenarios, and a time horizon (e.g., three years). An embodiment of the system may then, in operation 704, generate representations of multiple random simulation scenarios. Operation 704 may be similar to operation 506 in flow chart 500. An embodiment of the system may then, in operation 706, synchronize frequencies of the generated (or received) simulation scenarios and the received (or generated) stress test scenarios. Operation 706 may be similar to operation 510 in flow chart 500.

Operation 708 includes generating an extended decision structure across an extended time horizon for at least one period beyond the received time horizon. The number of historical simulations or stress scenarios received or generated for the decision structure may have only been enough to cover the number of periods included in the predetermined time horizon. Therefore, generating such an extended decision structure may include using data or hypotheses beyond the data and stress scenarios received or generated for the specified time horizon. For example, the stress test scenarios may be repeated for the future (e.g., extra) periods beyond the set time horizon. In another example, new simulations and scenarios may be generated or received. Operation 710 may include running simulations using the extended decision structure, including stress test scenarios, to entity data, which may be similar to operation 514 of flow chart 500. However, operation 710 may apply the new/extended decision structure to the entity data instead of the time horizon-limited decision structure.

The methods (e.g., flow charts 500, 600 and 700) may be described so that certain method operations are performed in a certain order. However, the order of the operations may be switched so that the method as a whole is still within embodiments of the present technology. Furthermore, certain method operations within flow charts 500, 600 and 700 may be described using certain specific examples (e.g., types of portfolios or financial data). However, any specific example used within the description herein may be used within the methods described in flow charts 500, 600 and 700.

Embodiments of the present technology may be further understood by the following non-limiting examples.

### EXAMPLE 1

1.1: Model

This simulation algorithm considers a multi-period, path-dependent model over a discrete time horizon, t=1, . . . , T. The example assumes a probability space (Ω, [symbol] , [symbol] ) and that Ω⊂ [symbol] with right-continuous and complete information filtration [symbol] =|{ [symbol] ₜ}, t=0, . . . , T. The nature of the probability measure [symbol] depends on the application. In risk management applications, [symbol] is the actual or statistical measure, while in valuation applications, [symbol] is a risk-neutral pricing measure, relative to which the discounted price of a traded security is a martingale.

A stochastic vector may be represented by xₜ where x_{t =(x}₁ₜ, . . . , xₙₜ). The realization xₜ at time t follows a true distribution, f(xₜ| [symbol] ₜ₋₁). The base model of the random vector in this example is g₀(xₜ| [symbol] ₜ₋₁). In addition, there are a few alternative distributions conditional on the economic states at time t. These alternative distributions are denoted by g₁ |(xₜ| [symbol] ₜ₋₁), where i=1, . . . , m. Therefore,

$$\begin{matrix}{x}_{t} = f ( {x}_{t} \vert {S}_{t} , {ℱ}_{t - 1} ) \\ = {g}_{i} ( {x}_{t} \vert ) if {S}_{t} = {S}_{i} ,\end{matrix} \qquad ( 2.1 )$$

where there are m+1 possible economic states and Sᵢ, i=0, . . . , m, is a particular state. The probability of the occurrence of a particular state is

$${p}_{i} = P ( {S}_{i} ) and {\sum }_{i = 0}^{m} {p}_{i} = 1. \qquad ( 2.2 )$$

The functions gᵢ(xₜ), i=0, . . . , m, are probability mass or density functions for state Sᵢ. In the context of integrating stress testing into classical risk models, the base model, g₀(xₜ), can be thought of as the base risk model. The i=1, . . . , m alternative distributions {gᵢ(xₜ)}₁₌₀^{m} represent stressed events that can happen but are not captured in the recent performance on which the base risk model, g₀(xₜ), is calibrated. Since the model xₜ=f(xₜ|Sₜ, [symbol] ᵢ₋₁) will be used as the representation of the actual distribution, it is important that it represents a probability mass or density function. The following theorem shows that this is indeed the case.
THEOREM 2.1 The function f(·) defined in (2.1) is a probability mass or density function.

At each time operation t=1, . . . , T, a switching function is first calculated in order to determine the state S of the time t. The switching function can be exogenous or endogenous on the realizations up to time t−1, xₜ₋₁. Given a realized state Sₜ=, i=0, . . . , m, at time t, a random vector, xₜ, is drawn from the distribution gᵢ. This process can then be repeated for time operation t+1 and x_{t+1.}

1.2: Encompassing structural-break models

The switching simulation model encompasses most of the well-known structural break models, including popular seasonal models, the Markov regime-switching models, the threshold autoregressive models, as well as their variants. The simplest cyclical effect model is seasonality. Many types of economic time series data such as gasoline prices, unemployment and retail sales exhibit a seasonality effect. A rudimental model with seasonality adjustment can be written as

$$\begin{matrix}{x}_{t} = {g}_{i} ( {x}_{t - 1} ) , \\ {g}_{i} ( {x}_{t - 1} ) = h ( {x}_{t - 1} ) + {L}_{i} ,\end{matrix} \} \qquad ( 2.3 )$$

where a deterministic seasonality effect Lᵢ, i=1, . . . , m, for m cyclical periods can be expressed using a deterministic vector v=(y₁, . . . , yₘ):

$${L}_{i} = \{ \begin{matrix}{γ}_{1} & if t is in period 1. \\ {γ}_{2} & if t is in period 2. \\ ⋮ & \\ {γ}_{m} & if t is in period m .\end{matrix}$$

In this case, the switching condition depends deterministically on the seasonal periods.

We assume that there are m competing models describing m economic states. That is,

$${x}_{t} = \{ \begin{matrix}{g}_{1} ( {x}_{t - 1} ) & if {S}_{t} = {S}_{1} , \\ {g}_{2} ( {x}_{t - 1} ) & if {S}_{t} = {S}_{2} , \\ ⋮ & \\ {g}_{m} ( {x}_{t - 1} ) & if {S}_{t} = {S}_{m} ,\end{matrix}$$

where the economic state transition follows a hidden Markov chain with transition probability

$$\begin{matrix}ℙ ( {S}_{t} = j \vert {S}_{t - 1} = i , {S}_{t - 2} = k , ⋯ , {x}_{t - 1} , {x}_{t - 2} , ⋯ ) = ℙ ( {S}_{t} = j \vert {S}_{t - 1} = i ) \\ = {P}_{ij} ,\end{matrix}$$

where, for each i, Σᵢ₌₁^{m}Pₜⱼ=1. An exogenous Markov chain drives the switching among the underlying states of the model.

An alternative model is a stochastic permanent break model, which is an approximation to the mean-plus-noise model. The mean-plus-noise model can also be supported by the Markov switching simulation with an exogenous switching method like the Markov regime-switching model.

The threshold autoregressive model is similar to the Markov regime switching models. However, instead of an exogenously driven switching among the states, the switching is determined by the underlying variables, making it self-exciting. Generally, a drift function of the underlying variable is associated with m −1 thresholds r, across which a state is entered. That is,

$${x}_{t} = \{ \begin{matrix}{g}_{1} ( {x}_{t - 1} ) & if h ( {x}_{t - 1} ) \leq {r}_{1} , \\ {g}_{2} ( {x}_{t - 1} ) & if {r}_{1} < h ( {x}_{t - 1} ) \leq {r}_{2} , \\ ⋮ & \\ {g}_{m} ( {x}_{t - 1} ) & if h ( {x}_{t - 1} ) < {r}_{m - 1} .\end{matrix}$$

In financial economics, the threshold autoregressive model families are used in a wide range of applications.

1.3: Integrated Stress Testing Using Markov Switching

A significant advantage of the switching simulation model is its possible integration of forward-looking hypothetical models into classical risk models that are calibrated based on data. Indeed, the Markov switching simulation can support the typical structural-break time series model as well as many deviations from a regular model setting. This is an important model feature as a stress test is essentially a deviation from the base model, i.e., a structural break from the base risk model and its parameters implied by the historical period of model calibration. The base model deviations may or may not be based on historical information. For example, forward-looking views on stressed events that may happen but have not happened before, or the inclusion of a historical crisis that may happen again but is not covered in the current base model calibration period. How to integrate scenario- and model-based stress testing using the switching simulation model will be discussed. An example model includes a single-period algorithm that superimposes a probability weighted exogenous rare event scenario to a classical risk model. In Berkowitz's model, stress testing is embedded within the VaR such that x=x, . . . , xₙ) is realized as

$$\begin{matrix}x \sim {g}_{0} ( x ) & with probability 1 - {\sum }_{l = 1}^{m} {α}_{1} , \\ x = {g}_{1} ( x ) & with probability {α}_{1} . \\ ⋮ & \\ x = {g}_{m} ( x ) & with probability {α}_{m} .\end{matrix}$$

where g₀(x) is the base risk model and g₁(x), . . . , gₘ(x) are point mass (stress) events. This model integration is motivated by the fact that stress events should represent potential future economic states and hence be part of the risk model forecast. VaR risk model analysis and stress testing can be two separate risk analysis tools. The VaR risk model is based on financial economic models calibrated from data. Stress tests are forward-looking risk analyses based on hypothetical assumptions and expert-knowledge-based economic projections or past experience. The comprehensive analysis of the tail behavior of a risk portfolio requires combining the empirical views with those of experts. A general simulation algorithm can be devised using the switching simulation method as follows.
(1) Start with the current base case scenario.
(2) Predefine the base risk model, g₀(xₜ), and the possible stress models and stress scenarios, g₁(xₜ), . . . , gₘ(xₜ). Note here that {gᵢ(xₜ)}ₜ₌₁^{m} can be either a degenerate risk factor stress event or a stress model parameterization such as a model for tilting the base model parameters, θ=(θ₁, . . . , θₖ), versus the base risk model, g₀(xₜ). A natural example is an increase in correlated dependence following a significant market downturn.
(3) At any time t , use a switching function to decide which model the replications should be drawn from. A pseudo-switching function code is if condition 1 then model= stress model 1, else if condition 2 then model= stress model 2, else if condition 3 then scenario= stress scenario 1, else model= base model. The conditions in the switching function can take many forms. They can be exogenous like a Markov chain, endogenous like a self-exiting process, or like a doubly stochastic process when stochastic switchings are nested.
(4) Draw from the conditional model or scenario.
(5) Repeat operations (3) and (4).

1.4: Event-based stress

In the case of event-based stresses, e.g., g₁(xₜ) , . . . , gₘ(xₜ) being point mass (stress) events at times t=1, . . . , T, the switching simulation method incorporates path dependency. The rare events are conditional on the previous horizon realization. When a rare event state occurs at time t , the corresponding scenario is a singleton mass. The realization at time t can either be from a normal state, S₀, or from an event Sᵢ, i=1, . . . , m. A series of rare events can be chained together on a simulation path, t=1, . . . , T. In this case, the path may experience bigger than usual losses and more hedging or capital coverage may be imposed. Suppose there are i=1, . . . , m events that have a causal relation. Consider a Markov chain with transition probability matrix from state Sᵢ, to Sⱼ being [symbol] =[pᵢⱼ], where i=0, 1, . . . , m and j=0, 1, . . . , m. For example, consider the event that a too-big-to-fail institution experiences a significant loss due to a fraud. Such an event at time t can lead to various subsequent market disruptions, at times t=t+1; t+2, . . . , that can take different paths. The occurrence of a rare stress event can not only be specified by an exogenous hidden process but also be triggered by the underlying risk factor realization from the base risk model. For example, as was experienced in the subprime mortgage crisis, when interest rates return from a low level regime they not only affect a consumer's financial situation directly but subsequently also affect a buyer's incentive to purchase properties, which eventually leads to lower property prices. As a further event, lower house prices and increased interest rates may trigger a cycle of substantially increased defaults. Obviously, the occurrence of a severe loss, distributed at t=1, . . . , T, is the outcome of several linked events. The rare event considered here bears a similarity to extended jump processes. However, a jump process is usually calibrated from historical data, where an unprecedented large loss rarely happens. The inclusion of stress events in the model admits consideration of “black swan” events into the risk model.

1.5: Model-based stress

Stress testing does not necessarily only take the form of rare events. A stress testing model {gᵢ(xₜ)}ᵢ₌₁^{m} may accommodate a parameter change versus the base risk model, g₀(xₜ). Explicitly, g₀(xₜ)=g₀(xₜ, θ₀) and the i=1, . . . , m stressed models have parameters {θ₁}ᵢ₌₁ₘ, such that {gᵢ(xₜ, θᵢ)}ᵢ₌₁^{m}. The above switching simulation algorithm can handle this case and the switching can be either exogenous or endogenous. In a base risk model it is natural to consider stochastic volatility as well as time-varying correlations. The multivariate GARCH model and its variants are popular models in practice. Many multivariate GARCH models are only feasible for a few assets. However, the dynamic conditional correlation method of Engle is feasible for a larger set of assets. Still, multivariate GARCH models for the base risk model are calibrated on historical performance and do not capture events that have not yet happened or are not included in the period of calibration. It is therefore prudent to consider potential switching of plausible stress events, where base model parameters can change suddenly to an extreme level. For example, a realized market downturn may induce sudden large increases in volatilities and correlations. While the GARCH models are designed to respond with higher volatility and correlation in the case of large shocks, they cannot readily accommodate sudden regime shifts.

1.6: Integrated stress testing and risk measures

VaR represents the maximum loss at a given confidence level. Specifically,

VaR(α)=inf[x|P(X≧x)≧α],

As a tail measure, all the tail information is located around the percentile point of the confidence level. Hence, VaR misses all tail loss information beyond the VaR point. This is a concern mainly if the tail risk loss is not smooth. In loss distributions with rare but severe loss impact events the VaR impact of the rare events may be minimal, only pushing the tail point upward. VaR is hence not a suitable measure for measuring extreme tail risk, especially in the presence of stress events. Consequently, Basel Committee on Banking Supervision (2012) considers replacing VaR as risk metric by expected shortfall (ES). The committee's main concern with VaR is indeed its inability to capture tail risk. Expected shortfall introduces a weight to all observations beyond the VaR point and hence incorporates all the severe events into the measure. It is defined as

ES(α)=E[X|X≧VaR(α)],

More generally, risk measures can be considered that take a weighted average of the tail points into account. These risk measures are called spectral risk measures. A spectral risk measure is always coherent. Spectral risk measures, especially ES, are also widely used by advanced scenario-based portfolio optimization, thanks to their nice coherent properties. With a scenario-based risk decision process the Markov switching simulation model can incorporate the stress testing into the risk-based optimization. Stress testing is no longer a complement to risk measurement. It can be integrated into all aspects of risk management.

1.7: Application

These examples discuss the effect of integrating stress tests into regular or base risk models using the switching simulation method. These examples use a linear portfolio with multivariate normal distribution as the base model. The first example is focused on event-based market risk stress. However, the bank's economic experts believe that a set of possible stress events can cause extreme losses for some positions in the portfolio, and as a result the aggregate portfolio profit and loss will be affected significantly. The risk manager is concerned that the base market risk model cannot incorporate these events. The second example focuses on significantly stressed model parameters in stress events: specifically, stressed volatilities and correlations.

In this case the risk manager is concerned that the base model volatility and correlation do not seem to capture the bank's view that, for a stressed event for an economic indicator, the correlation not only will increase within the portfolio but will increase significantly, ie, jump to a new stressed regime. Hence, with high probability, it causes much larger portfolio profit and loss than is implied by the base model specification.

These applications consider risk as measured over t=1, . . . , 10 days for the portfolio. They will consider a simple linear portfolio. It is not necessary to consider a more complex portfolio because the focus of these examples is on demonstrating applications of the integrated stress testing model using the Markov switching simulation method. However, as the integrated stress testing framework is simulation based it can be applied to any portfolio. The sample portfolio used in this example has six positions with a current mark-to-market of zero and these unit holding positions are denoted by P=(P₁, . . . , P₆). The distribution in the base risk model is multivariate normal with correlation matrix Ω for the six positions,

$$Ω = [ \begin{matrix}1 & & & & & \\ 0.5 & 1 & & & & \\ 0.5 & 0.5 & 1 & & & \\ 0.5 & 0.5 & 0.5 & 1 & & \\ 0.5 & 0.5 & 0.5 & 0.5 & 1 & \\ 0.5 & 0.5 & 0.5 & 0.5 & 0.5 & 1\end{matrix} ] ;$$

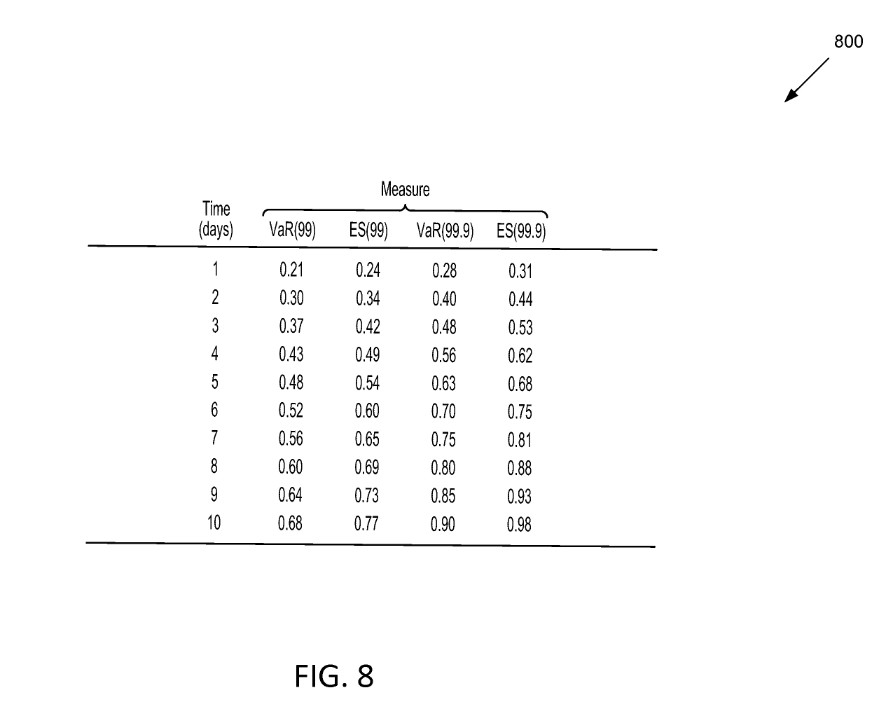

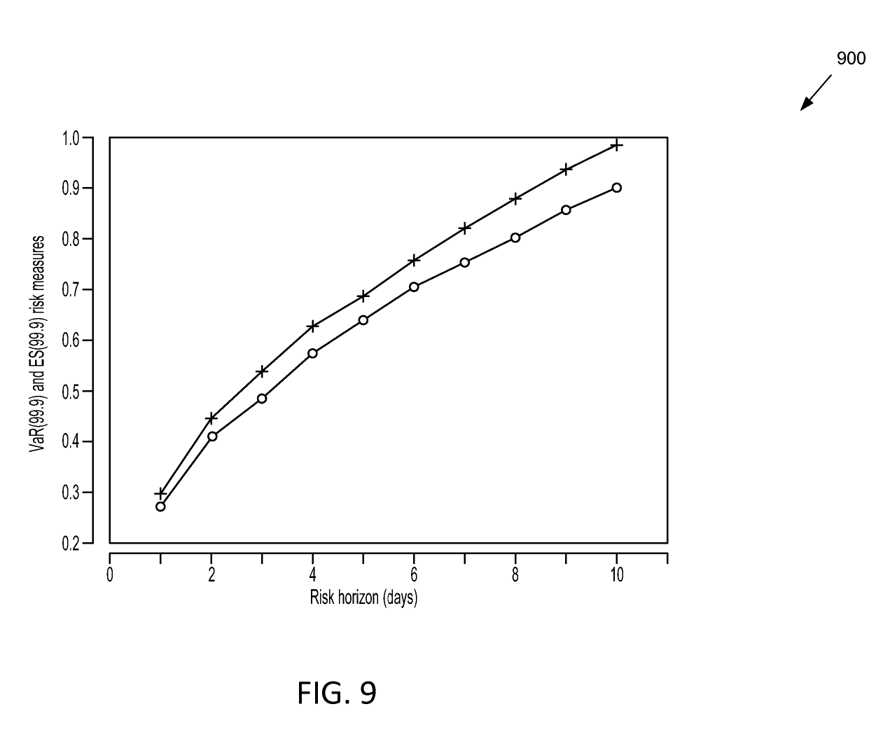

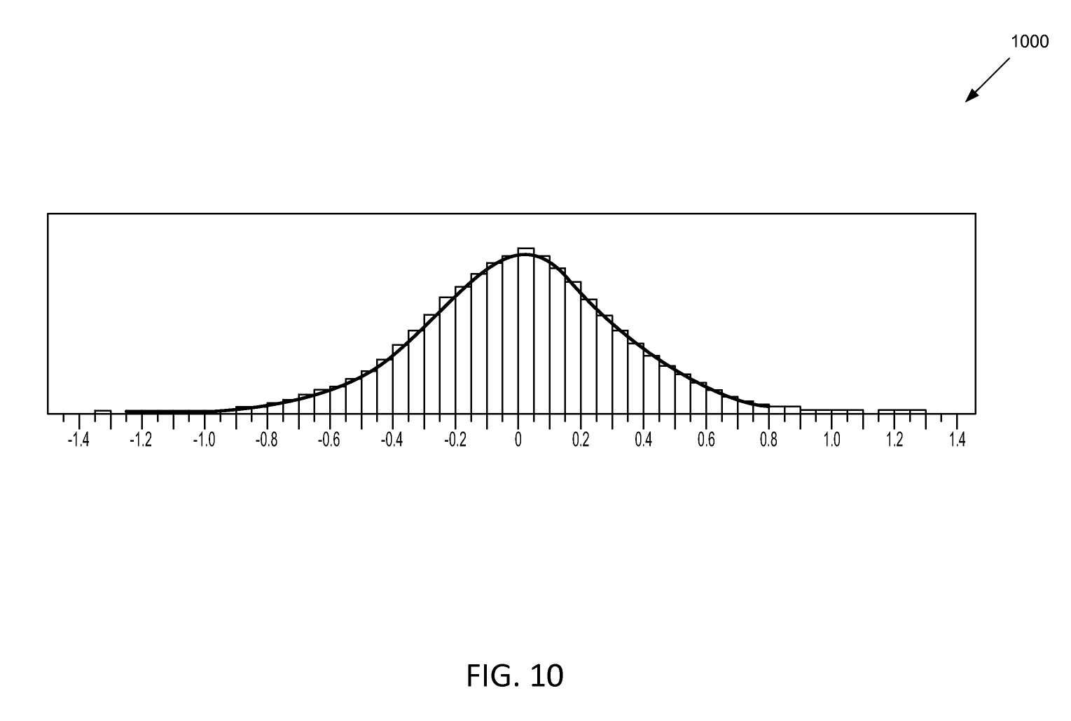

that is, an equicorrelation matrix with correlation parameter ρ equal to 0.5. The standard deviation, σ, is common for each position, {Pⱼ}ⱼ₌₁^{b}, and is set such that σ=1%. The resulting portfolio distribution is analytic and the base model portfolio risk VaR and ES at the 99% and 99.9% confidence levels, respectively, are given in table 800 of FIG. 8. Graph 900 of FIG. 9 displays the base risk model VaR(99:9) and ES(99:9) risk measures graphically over the risk horizon of t=1, . . . , 10 days. Graph 1000 of FIG. 10 displays the base risk model portfolio distribution at the terminal, i.e., t=10 days, risk horizon. Because of the multivariate normal distribution for portfolio positions, {Pⱼ}ⱼ₌₁^{G}, the resulting portfolio profit and loss distribution is normal for any t=1, . . . , 10 days risk horizon and the risk at t′=t+n can be obtained by multiplying the risk at t by \sqrt{n}. In this normal setting,

$$ES ( α ) = VaR ( α ) ( \frac{φ ( {Z}_{α} ) / ( 1 - φ ( {Z}_{α} ) )}{{Z}_{α}} ) .$$

where Φ is the cumulative distribution of the normal distribution, Φ is the probability density function of the normal distribution, and Z_{α}=Φ⁻¹ (α) is an quantile of the standard normal distribution. Consequently, VaR(α) and ES(α) are equivalent risk measures in this setting since they only differ by a constant.

1.8: Rare event scenarios

In the case of rare events six stress scenarios S=(S₁, . . . , S₆) are considered for the portfolio with positions P=(P₁, . . . , P₆). A rare event scenario shift is denoted as, Sᵢ, of position j by Pⱼ=−x, where x is the mark-to-market value of position j in the scenario. The following rare events are denoted:

S₁ [symbol] {P₁=−0.5, P₂=−0.5},

S₂ [symbol] {P₁=−0.25, P₂=−0.25},

S₃ [symbol] {P₁=−0.4, P₂=−0.4},

S₄ [symbol] {P₁=−0.1, P₂=−0.1},

S₅ [symbol] {P₁=−0.15, P₂=−0.15},

S₆ [symbol] {P₁=−0.18, P₂=−0.18},

Hence, only positions Pᵢ and P₂ are exposed to rare events. (Note that the rare event itself is specified on the risk factor level, ie, in this case on the equity risk factors. For our equity portfolio there is however a one-to-one correspondence between risk factor values and position values because the current mark-to-market is zero and each equity has a unit holding.) The unconditional probability of event i is common for all rare events i=1, . . . , 6 and is 0.1%. The conditional probability of rare event i′ happening after rare event i has happened is set to 0.1% if i′=i and to zero otherwise. Clearly, the assignment of conditional migration probabilities from one rare event to another depends on the exact relationships between the events. If the rare events are such that they represent i=1, . . . , n unrelated events, then it is natural to assign the conditional probability of migrating from event i to i′ to zero when i′≠i. However, if event i′ is regarded as an event that can follow as a consequence of event i , but cannot happen by itself, then the unconditional probability of event i′ is zero and the conditional probability of migrating from event i to i′ is nonzero. For example, a consumer credit stress may immediately, at t, give rise to a loss in positions with exposure to the credit market. It may also be followed by a subsequent, t+1, general downturn and hence affect more positions if the crisis spreads. However, note that even if a rare event is not followed by a new rare event, the effect of the rare event in scenario n and at time t is to move the stochastic realization of the vector x in scenario n and at time t . Hence, at scenario n and time t+1 the starting point is the rare event realization. In the case of a GARCH model the impact of the event is even more significant as the volatility impact is exponentially decaying. Therefore, in this rare event model, two effects are generally seen as a result of a rare event at t. First, the rare event may change the probability of that event being persistent (the conditional probability of the event is different from the unconditional probability). It may also be the case that once a rare event has happened, other rare events may likely follow. Second, even if the rare event is not followed by a rare event, the impact on risk is still substantial. Of course, the assignment of unconditional and conditional probabilities to events can be complex in practice. However, this is a core requirement to ensure proper integration of the stress events into the risk model, and hence arrive at a single consistent risk view that integrates all the information. The Rebonato model, while avoiding assignment of unconditional probabilities, includes a few analytical tools to assist in the conditional probability assignment.

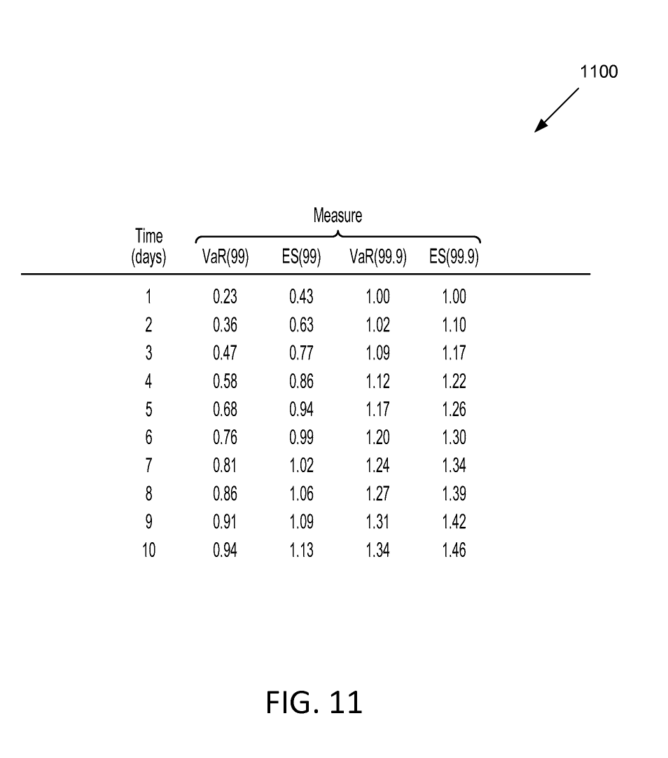

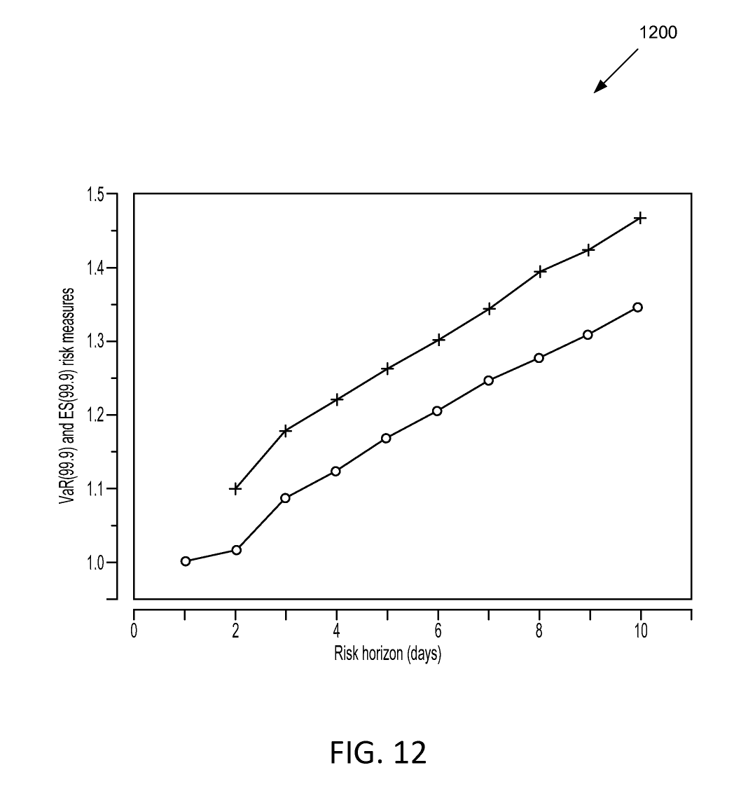

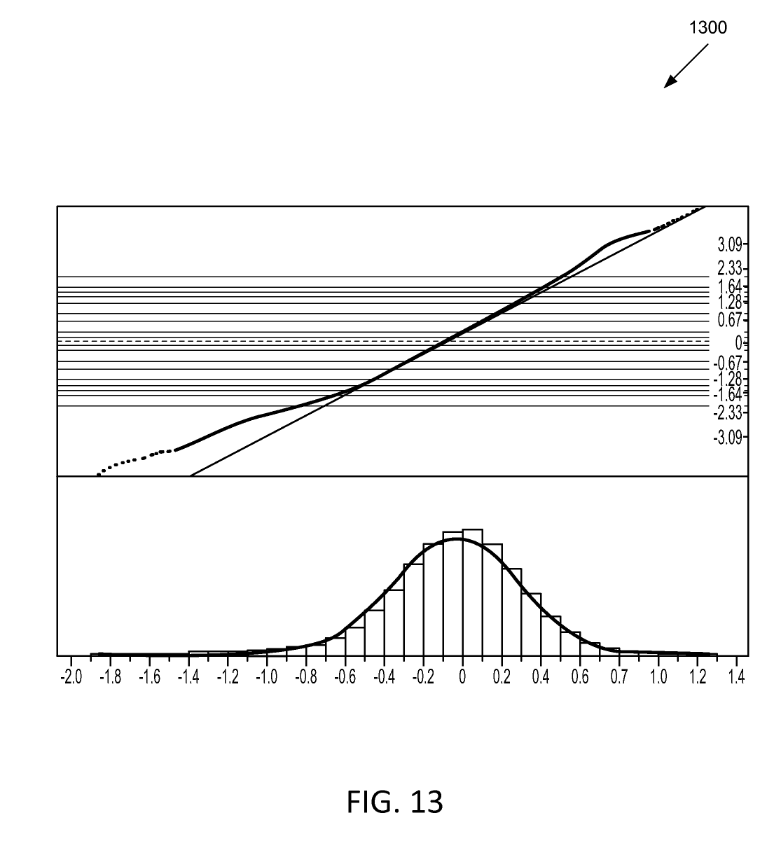

Table 1100 of FIG. 11 displays the integrated rare events risk model portfolio VaR and ES at the 99% and 99.9% confidence levels, respectively. The risk measures are calculated using 100 000 simulation replications. Graph 1200 of FIG. 12 displays the base risk model VaR(99.9) and ES(99.9) risk measures graphically over the t=1, . . . , 10 days risk horizon. Risk, as measured by VaR and ES, significantly increases when adding the rare events to the base risk model. At t=1, the 99.9% risk level VaR and ES have the same value of 1 unit of loss. This is the same loss as in scenario S₁ and happens because the VaR point, 99.9%, coincides with the probability of the scenario S₁: 0:1%. The VaR 99% in the rare events model for t=1 is more than 3.5 times as high as for the base risk model. However, as time moves forward, the relative VaR 99.9% difference between the rare events and base risk model decreases. At t=10 the ratio is approximately 1:48. This is because, in this model specification, once the large loss has happened there is no even larger loss that can happen. This is a consequence of the conditional probability of rare event i′ happening after rare event i being zero if i′≠i. It is interesting to consider a rare event realization in this model and the corresponding profit and losses observed over time. Consider, for example, a scenario where event S₃ happens at t=1. Clearly, at t=1 the impact of the rare event is to generate a portfolio loss of −0.8. After the rare event a new rare event may or may not happen. If a new rare event does not happen, the impact is to conserve a higher risk profile than normal for t=2. This is because the starting point, at t=2, is the rare event in t=1. This path-dependent model behavior is consistent with how stress events behave in reality. The impact of a stress should not be assessed at a single time horizon. Indeed, the evaluation of portfolio loss for a given stress event may require multiple horizons, and specifications of the potential sequential evolution of stress events for t=1, . . . , T using conditional migration probabilities. The relevant risk horizon considered should take account of the ability of the bank to properly liquidate or hedge positions adequately during that time. Indeed, the time horizon for liquidation may be significantly longer under stress than it is in normal situations. Graph 1300 of FIG. 13 displays the event risk model portfolio distribution at t=10 days risk horizon and the normal quantile plot for the distribution. The gray line indicates a fitted normal distribution. In contrast to the graph 1000 of FIG. 10 for the base risk model, the normal distribution does not fit the loss tail, as can be seen from both the normal quantile plot and the profit and loss distribution, which shows significantly larger losses than are implied by the normal base risk model.

### EXAMPLE 2

In this second a risk model, for example, with regime switching is considered for the model parameters in case of stress. Specifically, regime switching of volatilities and correlations are considered given a switching function that depends on an economic indicator, u, distributed as standard normal, N(0, 1), for all time horizons, t=1, . . . , 10. The economic indicator variable is correlated with the portfolio positions, P=(P₁, . . . , P₆), using the same correlation as that between the positions. It is natural to assume in this setting that the portfolio is correlated with the economic indicator (eg, if the portfolio is an equity portfolio and the economic indicator is a broad equity index).

Two different switching functions will be used to switch between the correlation matrixes, Ω, i.e., the base risk model correlation matrix, Ω_{S1} for the stressed regime 1, and Ω_{S2} for the stressed regime 2. In the first case the switching function is simple, with the actual correlation matrix, Ω, used at t+1 determined by

$$\tilde{Ω} ( t + 1 ) = \{ \begin{matrix}Ω & if \overline{u} ( t ) \geq 0.05 , \\ {Ω}_{{s}_{1}} & if 0.01 \leq \overline{u} ( t ) < 0.05 , \\ {Ω}_{{s}_{2}} & if \overline{u} ( t ) < 0.01 ,\end{matrix}$$

where ū=Φ(u) is the probability transformation of u to a uniform (0, 1) random variable. The second switching function uses a Markov conditional transition probability, pᵢⱼ, between the states i and j . In this example, state 1 represents the base risk model correlation matrix, state 2 the stressed regime 1 correlation matrix, and state 3 the stressed regime 2 correlation matrix, such that

$$P = [ \begin{matrix}{p}_{11} & {p}_{12} & {p}_{13} \\ {p}_{21} & {p}_{22} & {p}_{23} \\ {p}_{31} & {p}_{32} & {p}_{33}\end{matrix} ] {=}^{\vert} [ \begin{matrix}0.95 & 0.04 & 0.01 \\ 0.5 & 0.3 & 0.2 \\ 0.4 & 0.3 & 0.3\end{matrix} ] .$$

Conditional on a stressed correlation at t=1 there is therefore a greater likelihood of stressed correlation at t=2. The stressed regime 1 correlation matrix, Ω_{S1}, and the stressed regime 2 correlation matrix, Ω_{S2}, are given by

$${Ω}_{s 1} = [ \begin{matrix}1 & & & & & \\ 0.8 & 1 & & & & \\ 0.8 & 0.8 & 1 & & & \\ 0.8 & 0.8 & 0.8 & 1 & & \\ 0.8 & 0.8 & 0.8 & 0.8 & 1 & \\ 0.8 & 0.8 & 0.8 & 0.8 & 0.8 & 1\end{matrix} ] and$$

$${Ω}_{s 2} = [ \begin{matrix}1 & & & & & \\ 0.99 & 1 & & & & \\ 0.99 & 0.99 & 1 & & & \\ 0.99 & 0.99 & 0.99 & 1 & & \\ 0.99 & 0.99 & 0.99 & 0.99 & 1 & \\ 0.99 & 0.99 & 0.99 & 0.99 & 0.99 & 1\end{matrix} ] .$$

In addition to the correlation the common volatility will be changed for the base risk model, σ=1%, in the states to σ_{S1}=5% and σ_{S2}=10%, respectively.

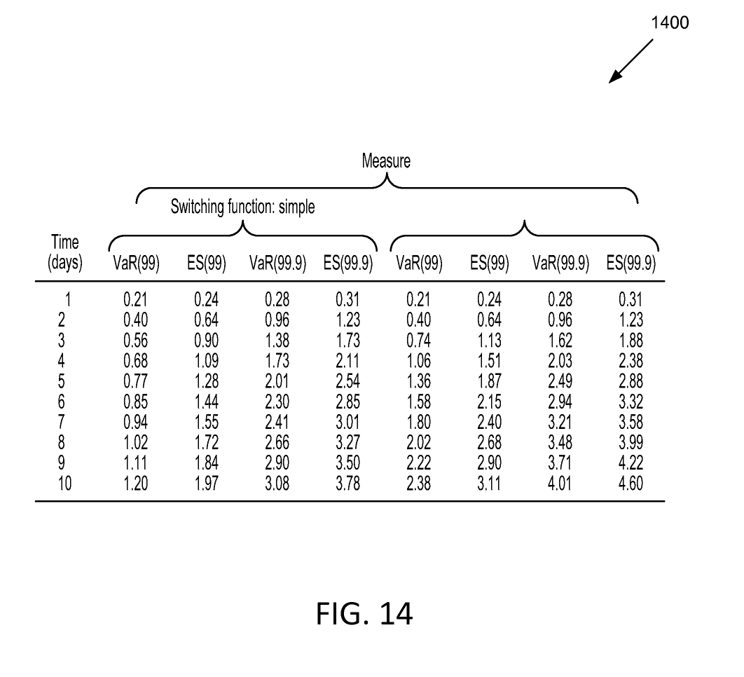

Table 1400 of FIG. 14 displays the regime-switching risk model portfolio risk VaR and ES at the 99% and 99.9% confidence levels, respectively. The risk measures are, as for the rare event model, calculated using 100,000 simulation replications. The risk, as measured by VaR and ES, is the same as for the base risk model for t=1. This is because, for both switching functions, switching at t+1 occurs based on the lagged indicator, u, at t. Subsequent risk at times t=2, . . . , 10 is, however, significantly higher compared with the base risk model. Note also that at t=2 there is the same VaR and ES for the simple and Markov switching models. This is because they have the same transition probabilities at t=2, based on the economic indicator at t=1, of switching to the stressed parameter states. After t=2 the Markov switching model has higher risk than the simple switching model, as the transition probabilities to a stressed state, given a stressed state has occurred, are much higher in the Markov switching model.

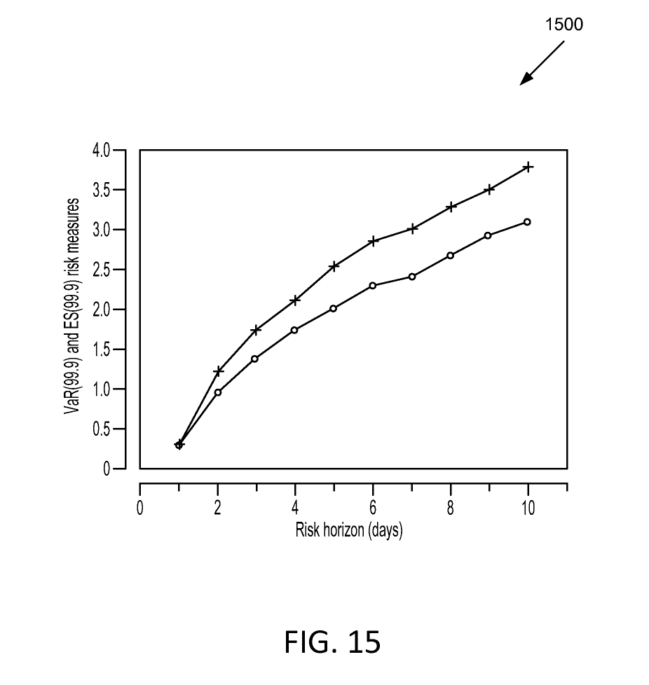

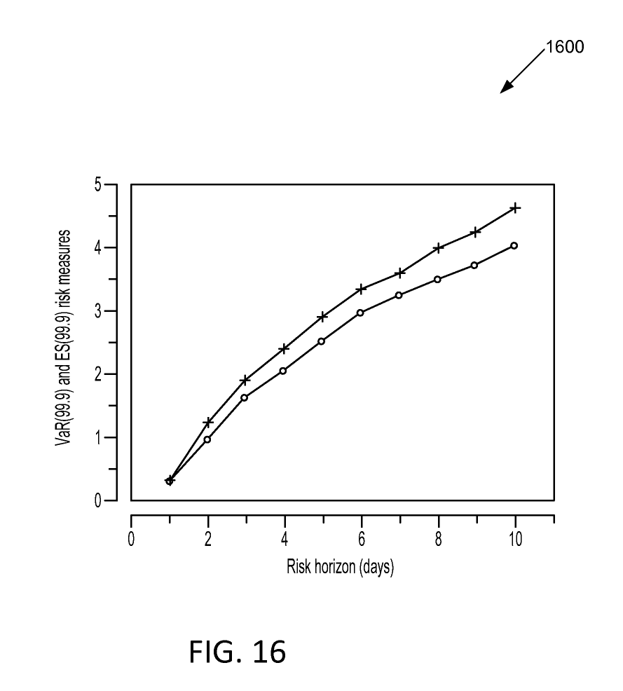

Graph 1500 of FIG. 15 displays the VaR(99.9) and ES(99.9) risk measures over the t=1, . . . , 10 days risk horizon for the simple switching function case, and graph 1600 of FIG. 16 displays the corresponding VaR(99.9) and ES(99.9) risk measures for the Markov switching function case. The relative increase in risk over time is seen to be substantially higher for the regime-switching models than it is in the base risk model case.

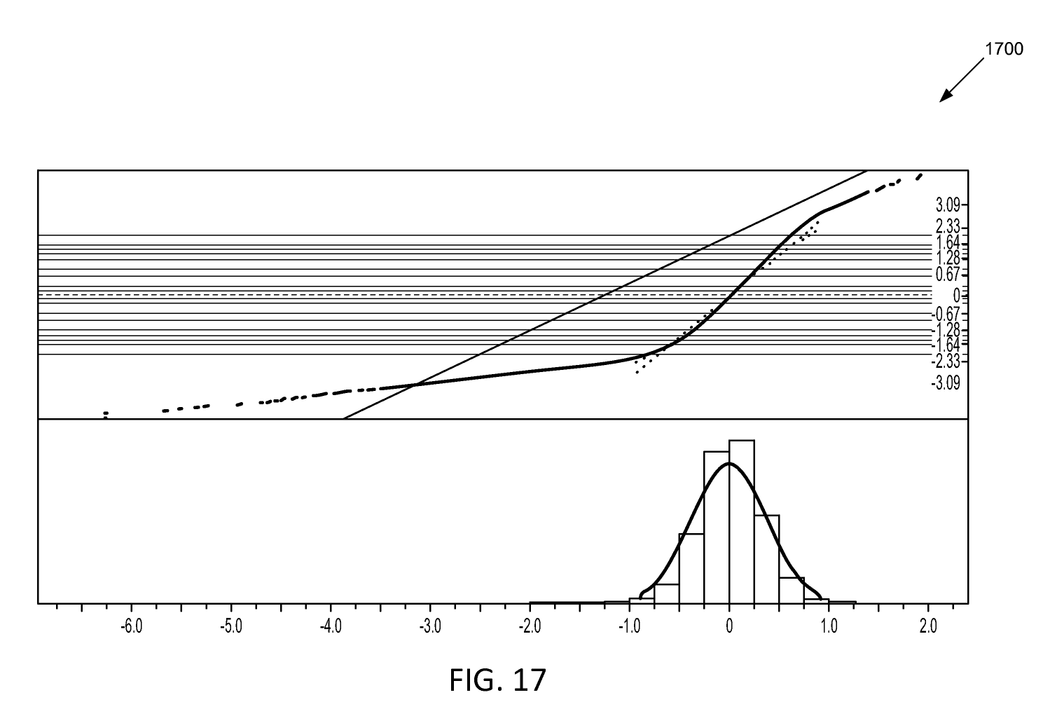

Graph 1700 of FIG. 17 displays the simple switching risk model portfolio distribution at t=10 days risk horizon together with the normal quantile plot. The gray line indicates the fitted normal distribution.

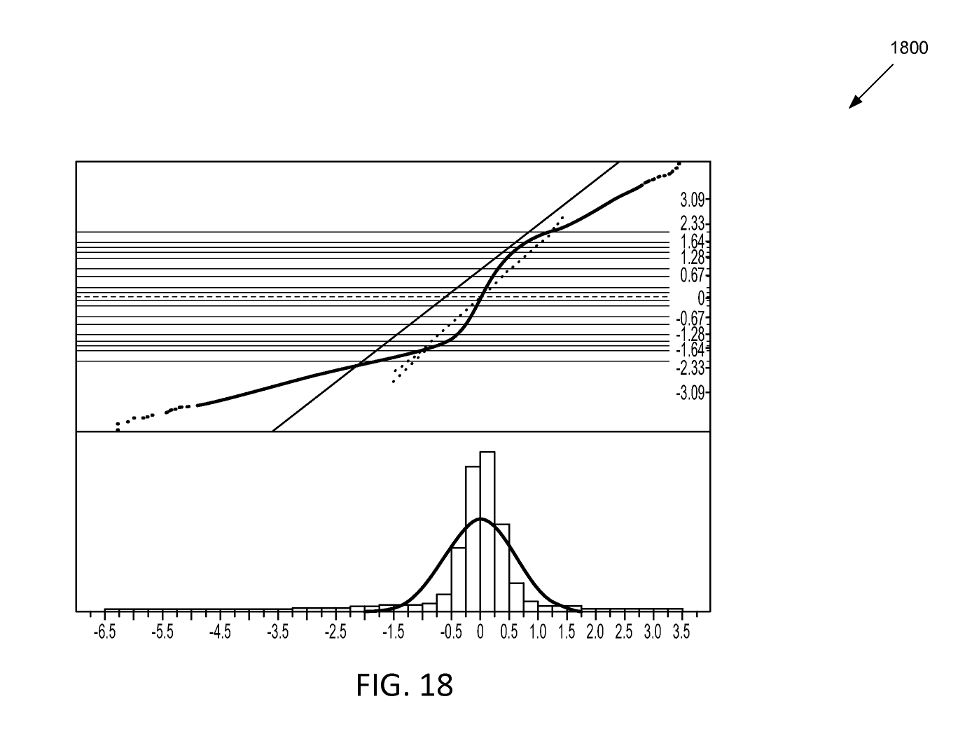

Graph 1800 of FIG. 18 displays the same portfolio distribution and normal quantile plot for the model with Markov switching. FIG. 18 displays distributions with a much fatter left tail than right tail. This is due to the fact that the economic indicator, u, has been correlated with the portfolio positions, P=(P1, . . . , P6). Hence, in states where the economic indicator has a very low value (i.e., a significant downturn), it is likely that the portfolio is experiencing a very large loss. This means that the switch to stressed correlation and volatility regimes will happen in states where large portfolio losses and economic downturn happens. This effect is further reinforced by the fact that the economic indicator correlation with the portfolio equity positions also switches to the stressed correlation level of the portfolio equity positions.

In some examples described herein, the systems and methods may include data transmissions conveyed via networks (e.g., local area network, wide area network, Internet, or combinations thereof, etc.), fiber optic medium, carrier waves, wireless networks, etc. for communication with one or more data processing devices. The data transmissions can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, removable memory, flat files, temporary memory, databases, programming data structures, programming variables, IF-THEN (or similar type) statement constructs, etc.). It is noted that data structures may describe formats for use in organizing and storing data in databases, programs, memory, or other computer-readable media for use by a computer program.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network. The processes and logic flows and figures described and shown in this specification can be performed by one or more programmable processors executing one or more computer programs to perform functions by operating on input data and generating output.

Generally, a computer can also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a tablet, a mobile viewing device, a mobile audio player, a Global Positioning System (GPS) receiver, to name just a few. Computer readable media suitable for storing computer program instructions and data include all forms of nonvolatile memory, media and memory devices, including by way of semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components or functionality may be located on a single computer or distributed across multiple computers depending upon the situation at hand.

The computer may include a programmable machine that performs high-speed processing of numbers, as well as of text, graphics, symbols, and sound. The computer can process, generate, or transform data. The computer includes a central processing unit that interprets and executes instructions; input devices, such as a keyboard, keypad, or a mouse, through which data and commands enter the computer; memory that enables the computer to store programs and data; and output devices, such as printers and display screens, that show the results after the computer has processed, generated, or transformed data.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated, processed communication, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a graphical system, a database management system, an operating system, or a combination of one or more of them.

The methods, systems, devices, implementations, and embodiments discussed above are examples. Various configurations may omit, substitute, or add various procedures or components as appropriate. For instance, in alternative configurations, the methods may be performed in an order different from that described, or various stages may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Some systems may use Hadoop®, an open-source framework for storing and analyzing big data in a distributed computing environment. Some systems may use cloud computing, which can enable ubiquitous, convenient, on-demand network access to a shared pool of configurable computing resources (e.g., networks, servers, storage, applications and services) that can be rapidly provisioned and released with minimal management effort or service provider interaction. Some grid systems may be implemented as a multi-node Hadoop® cluster, as understood by a person of skill in the art. Apache™ Hadoop® is an open-source software framework for distributed computing. Some systems may use the SAS® LASR™ Analytic Server in order to deliver statistical modeling and machine learning capabilities in a highly interactive programming environment, which may enable multiple users to concurrently manage data, transform variables, perform exploratory analysis, build and compare models and score. Some systems may use SAS In-Memory Statistics for Hadoop® to read big data once and analyze it several times by persisting it in-memory for the entire session.

Specific details are given in the description to provide a thorough understanding of examples of configurations (including implementations). However, configurations may be practiced without these specific details. For example, well-known circuits, processes, algorithms, structures, and techniques have been shown without unnecessary detail in order to avoid obscuring the configurations. This description provides examples of configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional operations not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several examples of configurations, various modifications, alternative constructions, and equivalents may be used without departing from the spirit of the disclosure. For example, the above elements may be components of a larger system, wherein other rules may take precedence over or otherwise modify the application of the current disclosure. Also, a number of operations may be undertaken before, during, or after the above elements are considered. Accordingly, the above description does not bound the scope of the claims.

The use of “capable of”, “adapted to”, or “configured to” herein is meant as open and inclusive language that does not foreclose devices adapted to or configured to perform additional tasks or operations. Additionally, the use of “based on” is meant to be open and inclusive, in that a process, operation, calculation, or other action “based on” one or more recited conditions or values may, in practice, be based on additional conditions or values beyond those recited. Headings, lists, and numbering included herein are for ease of explanation only and are not meant to be limiting.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

Some systems may use cloud computing, which can enable ubiquitous, convenient, on-demand network access to a shared pool of configurable computing resources (e.g., networks, servers, storage, applications and services) that can be rapidly provisioned and released with minimal management effort or service provider interaction. Some systems may use the SAS® LASR™ Analytic Server in order to deliver statistical modeling and machine learning capabilities in a highly interactive programming environment, which may enable multiple users to concurrently manage data, transform variables, perform exploratory analysis, build and compare models and score. Some systems may use SAS In-Memory Statistics for Hadoop® to read big data once and analyze it several times by persisting it in-memory for the entire session. Some systems may be of other types, designs and configurations.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations or additions to the present subject matter as may be readily apparent to one of ordinary skill in the art.

While this disclosure may contain many specifics, these should not be construed as limitations on the scope or of what may be claimed, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software or hardware product or packaged into multiple software or hardware products.

What is claimed is:

1. A computer-program product tangibly embodied in a non-transitory machine-readable storage medium, including instructions configured to cause a data processing apparatus to:
receive a representation of a series of time horizons, the series of time horizons having at least two consecutive future time periods;
receive an input representing stress test scenarios that have a stress test scenario frequency;
generate a set of representations of random simulation scenarios, the random simulation scenarios having a simulation scenario frequency;
synchronize the stress test scenario frequency and the simulation scenario frequency;
generate a decision data structure for the at least two consecutive future time periods, wherein for a future time period of the at least two consecutive future time periods the decision data structure includes a stress test scenario from the stress test scenarios and a probability of the stress test scenario occurring, and wherein the stress test scenario and the probability of the stress test scenario occurring are based at least in part on the decision data structure for a time period previous to the future time period and the random simulation scenarios; and
analyze entity data of an entity based on the decision data structure.

2. The computer-program product of claim 1, further comprising instructions configured to cause the data processing apparatus to:
generate a threshold data, the threshold data including a stress test scenario and a threshold probability of the stress test scenario occurring, wherein the threshold data is based on the stress test scenarios and the simulation scenarios.

3. The computer-program product of claim 2, further comprising instructions configured to cause the data processing apparatus to:
receive results data from analyzing the entity data of the entity based on the decision data structure;
compare the results data to the threshold data; and
adjust the entity data of the entity based on the comparison of the results data and the threshold data.

4. The computer-program product of claim 3, wherein instructions configured to cause the data processing apparatus to analyze entity data of an entity based on the decision data structure include instructions configured to cause the data processing apparatus to apply the probabilities of the stress test scenarios occurring at a future time period to the entity data of the entity to determine a possible outcome for the entity data at the future time period.

5. The computer-program product of claim 1, further comprising instructions configured to cause the data processing apparatus to:
generate a second set of representations of random simulation scenarios during a second series of time horizons, the second series of time horizons having at least two consecutive future time periods;
synchronize the stress test frequency and a second simulation frequency;
generate a second decision data structure for the second series of time horizons, wherein:
the second decision data structure includes a stress test scenario from the stress test scenarios and a probability of the stress test scenario occurring; and
the second decision data structure for a future time period of the second series of time horizons is based at least in part the second decision data structure for a time period previous to the future time period of the second series of time horizons and the second set of representations of random simulation scenarios; and
analyze the entity data of the entity based on the second decision data structure.

6. The computer-program product of claim 5, wherein the decision data structure and the second decision data structure are each a portion of the same data structure.

7. The computer-program product of claim 1, wherein synchronizing the stress test frequency and a second simulation frequency includes adjusting the stress test scenario frequency or the simulation scenario frequency.

8. The computer-program product of claim 1, further comprising instructions configured to cause the data processing apparatus to:
generate an extended decision data structure that includes at least one time period beyond the time horizon; and
analyze the entity data of the entity based on the extended decision data structure.

9. The computer-program product of claim 8, further comprising instructions configured to cause the data processing apparatus to:
generate a threshold data, the threshold data including a stress test scenario and a threshold probability of the stress test scenario occurring, wherein the threshold data is based on the stress test scenarios and the simulation scenarios;
receive extended results data from analyzing the entity data of the entity based on the extended decision data structure;
compare the extended results data to the threshold data; and
adjust the entity data of the entity based on the comparison of the extended results data and the threshold data.

10. A system, comprising:
an input interface, configured to receive a representation of a series of time horizons, the series of time horizons having at least two consecutive future time periods;
a stress test scenario store, configured to receive an input representing stress test scenarios that have a stress test scenario frequency;
a simulation scenarios generator, configured to generate a set of representations of random simulation scenarios, the random simulation scenarios having a simulation scenario frequency;
a frequency adjuster engine, configured to synchronize the stress test scenario frequency and the simulation scenario frequency;
a decision structure generator, configured to generate a decision data structure for the at least two consecutive future time periods, wherein for a future time period of the at least two consecutive future time periods the decision data structure includes a stress test scenario from the stress test scenarios and a probability of the stress test scenario occurring, and wherein the stress test scenario and the probability of the stress test scenario occurring are based at least in part on the decision data structure for a time period previous to the future time period and the random simulation scenarios; and
an application and evaluation engine, configured to analyze entity data of an entity based on the decision data structure.

11. The system of claim 10, wherein the application and evaluation engine is further configured to:
generate a threshold data, the threshold data including a stress test scenario and a threshold probability of the stress test scenario occurring, wherein the threshold data is based on the stress test scenarios and the simulation scenarios.

12. The system of claim 11, wherein the application and evaluation engine is further configured to:
receive results data from analyzing the entity data of the entity based on the decision data structure;
compare the results data to the threshold data; and
adjust the entity data of the entity based on the comparison of the results data and the threshold data.

13. The system of claim 12, wherein the application and evaluation engine is further configured to apply the probabilities of the stress test scenarios occurring at a future time period to the entity data of the entity to determine a possible outcome for the entity data at the future time period.

14. The system of claim 10, wherein:
the simulation scenarios generator is further configured to generate, by a computing device, a second set of representations of random simulation scenarios during a second series of time horizons, the second series of time horizons having at least two consecutive future time periods;
the frequency adjuster engine is further configured to synchronize the stress test frequency and a second simulation frequency;
the decision structure generator is further configured to generate a second decision data structure for the second series of time horizons, wherein:
the second decision data structure includes a stress test scenario from the stress test scenarios and a probability of the stress test scenario occurring; and
the second decision data structure for a future time period of the second series of time horizons is based at least in part the second decision data structure for a time period previous to the future time period of the second series of time horizons and the second set of representations of random simulation scenarios; and
the application and evaluation engine is further configured to analyze the entity data of the entity based on the second decision data structure.

15. The system of claim 14, wherein the decision data structure and the second decision data structure are each a portion of the same data structure.

16. The system of claim 10, wherein synchronizing the stress test frequency and a second simulation frequency includes adjusting the stress test scenario frequency or the simulation scenario frequency.

17. The system of claim 10, wherein:
the decision structure generator is further configured to generate an extended decision data structure that includes at least one time period beyond the time horizon; and
the application and evaluation engine is further configured to analyze the entity data of the entity based on the extended decision data structure.

18. The system of claim 17, wherein the application and evaluation engine is further configured to:
generate a threshold data, the threshold data including a stress test scenario and a threshold probability of the stress test scenario occurring, wherein the threshold data is based on the stress test scenarios and the simulation scenarios;
receive extended results data from analyzing the entity data of the entity based on the extended decision data structure;
compare the extended results data to the threshold data; and
adjust the entity data of the entity based on the comparison of the extended results data and the threshold data.

19. A computer-implemented method, comprising:
receiving a representation of a series of time horizons, the series of time horizons having at least two consecutive future time periods;
receiving an input representing stress test scenarios that have a stress test scenario frequency;
generating a set of representations of random simulation scenarios, the random simulation scenarios having a simulation scenario frequency;
synchronizing the stress test scenario frequency and the simulation scenario frequency;
generating a decision data structure for the at least two consecutive future time periods, wherein for a future time period of the at least two consecutive future time periods the decision data structure includes a stress test scenario from the stress test scenarios and a probability of the stress test scenario occurring, and wherein the stress test scenario and the probability of the stress test scenario occurring are based at least in part on the decision data structure for a time period previous to the future time period and the random simulation scenarios; and
analyzing entity data of an entity based on the decision data structure.

20. The method of claim 19, further comprising:
generating a threshold data, the threshold data including a stress test scenario and a threshold probability of the stress test scenario occurring, wherein the threshold data is based on the stress test scenarios and the simulation scenarios.

21. The method of claim 20, further comprising:
receiving results data from analyzing the entity data of the entity based on the decision data structure;
comparing the results data to the threshold data; and
adjusting the entity data of the entity based on the comparison of the results data and the threshold data.

22. The method of claim 21, wherein analyzing entity data of an entity based on the decision data structure includes applying the probabilities of the stress test scenarios occurring at a future time period to the entity data of the entity to determine a possible outcome for the entity data at the future time period.

23. The method of claim 19, further comprising:
generating a second set of representations of random simulation scenarios during a second series of time horizons, the second series of time horizons having at least two consecutive future time periods;
synchronizing the stress test frequency and a second simulation frequency;
generating a second decision data structure for the second series of time horizons, wherein:
the second decision data structure includes a stress test scenario from the stress test scenarios and a probability of the stress test scenario occurring; and
the second decision data structure for a future time period of the second series of time horizons is based at least in part the second decision data structure for a time period previous to the future time period of the second series of time horizons and the second set of representations of random simulation scenarios; and
analyzing the entity data of the entity based on the second decision data structure.

24. The method of claim 23, wherein the decision data structure and the second decision data structure are each a portion of the same data structure.

25. The method of claim 19, wherein synchronizing the stress test frequency and a second simulation frequency includes adjusting the stress test scenario frequency or the simulation scenario frequency.

26. The method of claim 19, further comprising:
generating an extended decision data structure that includes at least one time period beyond the time horizon; and
analyzing the entity data of the entity based on the extended decision data structure.

27. The method of claim 26, further comprising:
generating a threshold data, the threshold data including a stress test scenario and a threshold probability of the stress test scenario occurring, wherein the threshold data is based on the stress test scenarios and the simulation scenarios;
receiving extended results data from analyzing the entity data of the entity based on the extended decision data structure;
comparing the extended results data to the threshold data; and
adjusting the entity data of the entity based on the comparison of the extended results data and the threshold data.
